(19) United States
(12) Patent Application Publication
(10) Pub. No.: US 2026/0126712 A1
(43) Pub. Date: May 7, 2026

(54) ILLUMINATION SYSTEM AND A PROJECTION DEVICE

(71) Applicant: Coretronic Corporation, Hsin-Chu (TW)

(72) Inventors: Yi-Hsuang WENG, Hsin-Chu (TW); Chun-Hsin LU, Hsin-Chu (TW); Wen-Chieh CHUNG, Hsin-Chu (TW)

(21) Appl. No.: 19/366,496

(22) Filed: Oct. 22, 2025

(30) Foreign Application Priority Data
Nov. 5, 2024 (CN) 2024115630002

(51) Int. Cl. G03B 21/20

(52) U.S. Cl. CPC G03B 21/2013; G03B 21/2066

(57) ABSTRACT

The present disclosure is related to an illumination system and a projection device including a first light source module, a second light source module and a first light splitting element. The first light splitting element reflects a first beam of the first light source module. The first light splitting element allows a second beam of the second light source module pass through and be transmitted to the optical element. The light spots formed by the first beam and the second beam on the optical element at least partially overlap and form a first light spot group and a second light spot group. The first light spot group and the second light spot group are arranged along the first direction. The illumination system and the projection device of the present disclosure effectively improve the brightness of an illumination beam.

### CROSS-REFERENCES

This application claims the priority benefit of Chinese Patent Application Serial Number 2024115630002, filed on Nov. 5, 2024, the full disclosure of which is incorporated herein by reference.

### TECHNICAL FIELD

The present disclosure is related to optical systems and electronic devices. More particularly, the embodiments are related to an illumination system and a projection device.

### DESCRIPTION OF RELATED ART

A projection device (such as a projector) is a display device that generates a display image. The imaging principle of the projection device is to convert the illumination beam generated by the illumination system into an image beam through a light valve and project the image beam onto a projection surface such as a screen or a wall through a projection lens. As the projection device is widely used in different environments, the projection device is also correspondingly designed to have a smaller size. In order to increase the brightness of the illumination beam, multiple light sources are usually combined to achieve a light combination. However, the size of the light spot formed by the multiple light sources on the optical element is too large, resulting in a corresponding increase in the volume of the projection device.

The information disclosed in this DESCRIPTION OF RELATED ART section is only for enhancement of understanding of the background of the described technology and therefore it may contain information that does not form the prior art that is already known to a person of ordinary skill in the art. Further, the information disclosed in the DESCRIPTION OF RELATED ART section does not mean that one or more problems to be resolved by one or more embodiments of the disclosure was acknowledged by a person of ordinary skill in the art.

### SUMMARY OF THE INVENTION

The embodiment of the present disclosure provides an illumination system and a projection device to allow at least two light spots at least partially overlapping on an optical element to effectively increase the brightness of an illumination beam without increasing the volume of the projection device.

In order to achieve the above object and other related objects, the present disclosure provides an illumination system including a first light source module, a second light source module and a first light splitting element. The first light source module provides a first beam transmitted along a first direction. The first beam includes at least one of a first sub beam, a second sub beam and a third sub beam. The second light source module provides a second beam transmitted along a second direction. The second beam includes at least one of a first sub beam, a second sub beam and a third sub beam. The first direction is different from the second direction. The first light splitting element is disposed between the first light source module and the second light source module. The first light splitting element reflects the first beam to cause the first beam to be transmitted to an optical element along the second direction. The first light splitting element allows the second beam to pass through and be transmitted to the optical element along the second direction. The light spots formed on the optical element by the first sub beam of the first beam are at least partially overlapped with the light spots formed on the optical element by the second sub beam and the third sub beam of the second beam to form a first light spot group. The light spots formed on the optical element by the first sub beam of the second beam are at least partially overlapped with the light spots formed on the optical element by the second sub beam and the third sub beam of the first beam to form a second light spot group. The first light spot group and the second light spot group are arranged along the first direction.

In order to achieve the above object and other related objects, the present disclosure provides a projection device. The projection device includes the aforementioned illumination system, a light valve module and a projection lens. The illumination system provides an illumination beam. The illumination beam includes at least one of the first beam and the second beam from the optical element. The light valve module is disposed on the transmission path of the illumination beam and is configured to convert the illumination beam into an image beam. The projection lens is disposed on the transmission path of the image beam and is configured to project the image beam out of the projection device.

According to the above, the embodiments of the present disclosure at least have one of the following beneficial effects: The illumination system and projection device of the embodiments of the present disclosure allow at least two light spots to at least partially overlap on the optical element, which may effectively increase the brightness of the illumination beam without increasing the volume of the projection device.

Other objectives, features and advantages of the present invention will be further understood from the further technological features disclosed by the embodiments of the present invention, wherein there are shown and described preferred embodiments of this invention, simply by way of illustration of modes best suited to carry out the invention.

### BRIEF DESCRIPTION OF DRAWINGS

FIG. 1 is a schematic of a projection device according to an embodiment of the present disclosure.

FIG. 2 is a schematic of example 1 of an illumination system according to an embodiment of the present disclosure.

FIG. 3 is a schematic of a configuration example 1 of a light splitting element according to an embodiment of the present disclosure.

FIG. 4 is a schematic of a light source module according to an embodiment of the present disclosure.

FIG. 5 is a schematic of example 1 of the light splitting element according to an embodiment of the present disclosure.

FIG. 6 is a schematic of wavelengths of a first light splitting zone according to an embodiment of the present disclosure.

FIG. 7 is a schematic of wavelengths of a second light splitting zone according to an embodiment of the present disclosure.

FIG. 8 is a schematic of example 1 of light spots according to an embodiment of the present disclosure.

FIG. 9 is a schematic of example 2 of an illumination system according to an embodiment of the present disclosure.

FIG. 10 is another schematic of example 2 of an illumination system according to an embodiment of the present disclosure.

FIG. 11 is a schematic of a configuration example 2 of the light splitting element according to an embodiment of the present disclosure.

FIG. 12 is a schematic of example 2 of the light splitting element according to an embodiment of the present disclosure.

FIG. 13 is a schematic of example 2 of light spots according to an embodiment of the present disclosure.

FIG. 14 is a schematic of example 1 of an optical element according to an embodiment of the present disclosure.

FIG. 15 is a schematic of example 3 of an illumination system according to an embodiment of the present disclosure.

FIG. 16 is another schematic of example 3 of the illumination system according to an embodiment of the present disclosure.

FIG. 17 is a schematic of example 2 of an optical element according to an embodiment of the present disclosure.

FIG. 18 is a schematic of example 3 of light spots according to an embodiment of the present disclosure.

FIG. 19 is a schematic of example 4 of an illumination system according to an embodiment of the present disclosure.

FIG. 20 is a partial schematic of example 4 of the illumination system according to an embodiment of the present disclosure.

FIG. 21 is a schematic of example 3 of an optical element according to an embodiment of the present disclosure.

FIG. 22 is a schematic of example 4 of light spots according to an embodiment of the present disclosure.

FIG. 23 is a schematic of example 5 of an illumination system according to an embodiment of the present disclosure.

FIG. 24 is a schematic of example 5 of light spots according to an embodiment of the present disclosure.

FIG. 25 is a schematic of example 4 of an optical element according to an embodiment of the present disclosure.

FIG. 26 is a schematic of example 6 of an illumination system according to an embodiment of the present disclosure.

FIG. 27 is a schematic of example 6 of light spots according to an embodiment of the present disclosure.

FIG. 28 is a schematic of example 7 of an illumination system according to an embodiment of the present disclosure.

FIG. 29 is a schematic of a configuration example 3 of a light splitting element according to an embodiment of the present disclosure.

FIG. 30 is a schematic of example 3 of a light splitting element according to an embodiment of the present disclosure.

FIG. 31 is a schematic of example 7 of light spots according to an embodiment of the present disclosure.

FIG. 32 is a schematic of example 8 of an illumination system according to an embodiment of the present disclosure.

FIG. 33 is a schematic of example 8 of light spots according to an embodiment of the present disclosure.

FIG. 34 is a schematic of example 5 of an optical element according to an embodiment of the present disclosure.

FIG. 35 is a schematic of example 9 of an illumination system according to an embodiment of the present disclosure.

FIG. 36 is a schematic of a configuration example 4 of a light splitting element according to an embodiment of the present disclosure.

FIG. 37 is a schematic of example 4 of a light splitting element according to an embodiment of the present disclosure.

FIG. 38 is a schematic of example 9 of light spots according to an embodiment of the present disclosure.

FIG. 39 is a schematic of example 6 of an optical element according to an embodiment of the present disclosure.

### DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing.” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component being “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

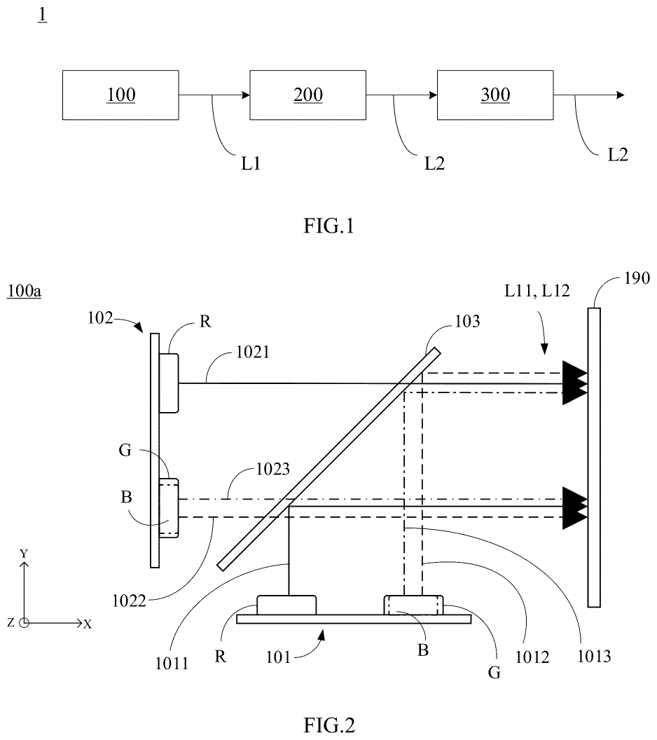

Please refer to FIG. 1. FIG. 1 is a schematic of a projection device according to an embodiment of the present disclosure. The projection device (such as a projector) 1 includes an illumination system 100, a light valve module 200 and a projection lens 300. An illumination beam L1 is provided to the light valve module 200 by the illumination system 100. The illumination system 100 may include an optical element including at least one of a wavelength conversion element (such as a phosphor wheel), a light homogenization element (such as an integrating rod), a filter element (such as a filter wheel), and a plurality of light separation and combination elements.

The light valve module 200 is disposed on the transmission path of the illumination beam L1. The light valve module 200 is configured to convert the illumination beam L1 into an image beam L2 and to transmit the image beam L2 to the projection lens 300. The light valve module 200 may be a reflective light modulator such as a digital micromirror device (DMD) and a liquid crystal on silicon panel (LCoS panel), or a transmissive light modulator such as a transparent liquid crystal panel, an electro-optical modulator, a magneto-optic modulator and an acousto-optic modulator (AOM).

The projection lens 300 is disposed on the transmission path of the image beam L2 from the light valve module 200 to project the image beam L2 out of the projection device 1 to a projection target. The projection target is, for example, a screen or a wall. The projection lens 300 includes, for example, a combination of one or more optical lenses having diopter, such as various combinations of non-planar lenses such as a biconcave lens, a biconvex lens, a concave-convex lens, a convex-concave lens, a plano-convex lens, and a plano-concave lens. In other embodiments, the projection lens 300 may include a flat optical lens to project the image beam L2 to the projection target in a reflection manner. The present disclosure does not limit the type and form of the projection lens 300.

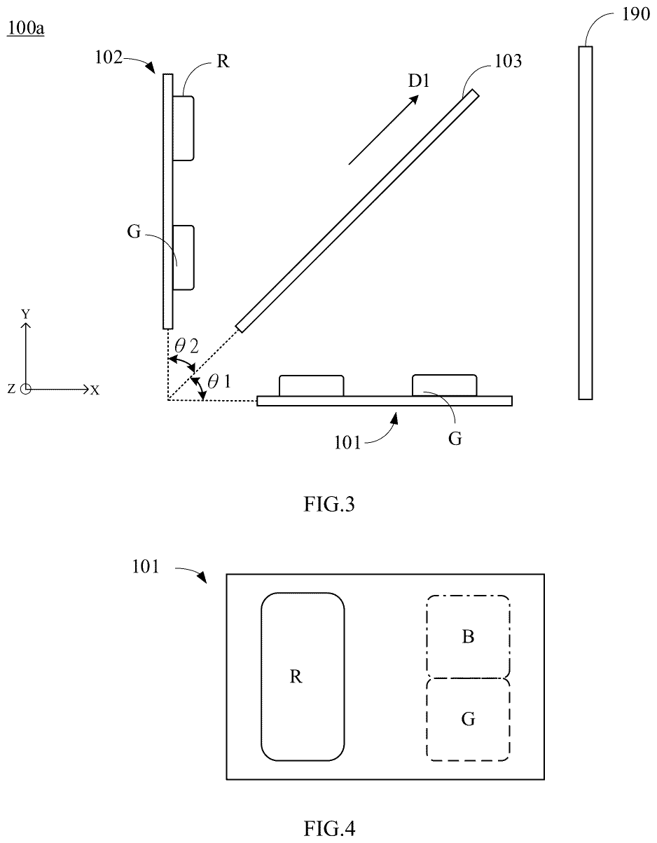

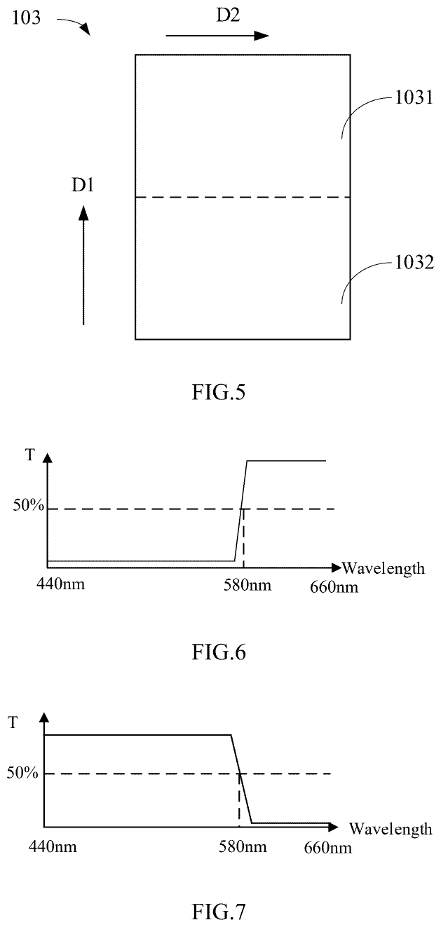

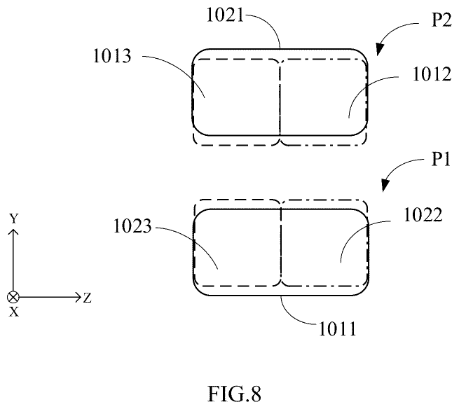

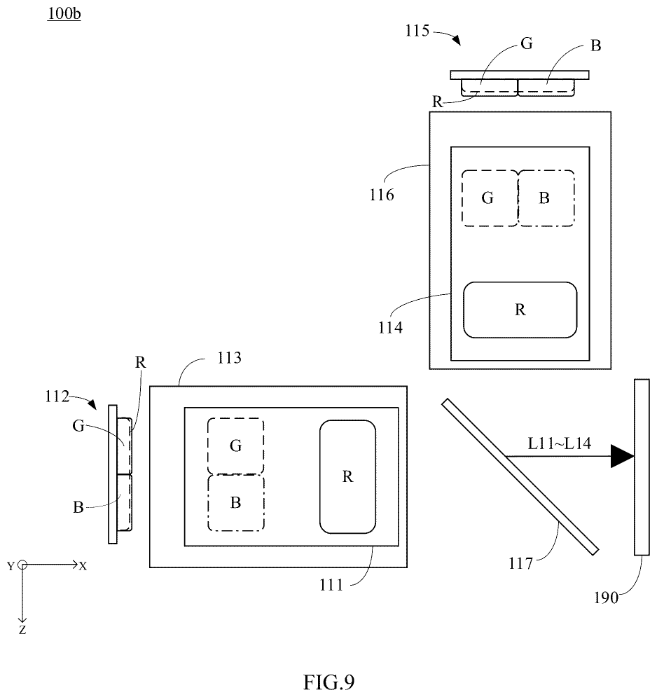

Please refer FIG. 2 to FIG. 8. FIG. 2 is a schematic of an illumination system according to an embodiment of the present disclosure. FIG. 3 is a schematic of a configuration example of a light splitting element according to an embodiment of the present disclosure. FIG. 4 is a schematic of a light source module according to an embodiment of the present disclosure. FIG. 5 is a schematic of the light splitting element according to an embodiment of the present disclosure. FIG. 6 and FIG. 7 are schematics of wavelengths of light splitting zones according to an embodiment of the present disclosure. FIG. 8 is a schematic of light spots according to an embodiment of the present disclosure. A first direction Y, a second direction X and a third direction Z are shown in the figures to clearly show the viewing angle of each figure. The first direction Y and the second direction X are perpendicular to each other in the figures. The third direction Z is perpendicular to both the first direction Y and the second direction X. In the embodiment, the illumination system 100a includes a first light source module 101, a second light source module 102, and a first light splitting element 103. The illumination system 100a further includes an optical element 190. The optical element 190 is, for example, a lens. The lens may be, for example, a condenser lens.

The first light source module 101 includes a first light emitting unit R, a second light emitting unit G and a third light emitting unit B, as shown in FIG. 4. The second light emitting unit G and the third light emitting unit B are disposed in parallel. The positions of the second light emitting unit G and the third light emitting unit B may be interchanged according to needs. The first light emitting unit R is located on the same side as the second light emitting unit G and the third light emitting unit B. The numbers of the first light emitting unit R, the second light emitting unit G and the third light emitting unit B may be plural. The number of the first light emitting units R is, for example, eight. Every two first light emitting units R form a group. Each group of two first light emitting units R corresponds to a collimating lens. The number of the second light emitting units G is, for example, three. Each second light emitting unit G corresponds to a collimating lens. The number of the third light emitting units B is, for example, two. Each third light emitting unit B corresponds to a collimating lens. Each light emitting unit is, for example, a light emitting diode or a laser diode, or may be other types of light sources. The first light source module 101 may be a light emitting diode array or a laser diode array. The first light source module 101 is configured to provide a first beam L11 transmitted along the first direction Y. The first beam L11 includes at least one of a first sub beam 1011, a second sub beam 1012, and a third sub beam 1013. In the embodiment, the first light emitting unit R is configured to provide the first sub beam 1011, the second light emitting unit G is configured to provide the second sub beam 1012, and the third light emitting unit B is configured to provide the third sub beam 1013. In the embodiment, the first light emitting unit R is a red light emitting unit, and the first sub beam 1011 is a red light beam. In the embodiment, the second light emitting unit G is a green light emitting unit, and the second sub beam 1012 is a green light beam. In the embodiment, the third light emitting unit B is a blue light emitting unit, and the third sub beam 1013 is a blue light beam.

The second light source module 102 includes a first light emitting unit R, a second light emitting unit G and a third light emitting unit B. The second light source module 102 may be implemented by the embodiment of FIG. 4. The second light source module 102 is configured to provide a second beam L12 transmitted along the second direction X. The second beam L12 includes at least one of a first sub beam 1021, a second sub beam 1022, and a third sub beam 1023. In the embodiment, the first light emitting unit R is configured to provide the first sub beam 1021, the second light emitting unit G is configured to provide the second sub beam 1022, and the third light emitting unit B is configured to provide the third sub beam 1023.

In the embodiment, the extension direction of the first light source module 101 is parallel to the second direction X and the third direction Z, and the extension direction of the second light source module 102 is parallel to the first direction Y and the third direction Z. On a reference plane perpendicular to the third direction Z, the first light source module 101 and the second light source module 102 are arranged in an L shape.

The first light splitting element 103 is disposed between the first light source module 101 and the second light source module 102. The extension direction of the first light splitting element 103 is parallel to a first extension direction D1 and a second extension direction D2. The first extension direction D1 is, for example, a direction that is 45 degrees to the first direction Y and the second direction X, respectively. The second extension direction D2 is, for example, parallel to the third direction Z. An extension plane of the first light splitting element 103 and an extension plane of the first light source module 101 have an included angle θ1. The extending plane of the first light splitting element 103 and an extending plane of the second light source module 102 have an included angle θ2. The included angle θ1 and the included angle θ2 are, for example, 45 degrees. The first light splitting element 103 is configured to reflect the first beam L11 from the first light source module 101 to cause the first beam L11 to be transmitted to the optical element 190 along the second direction X. The first light splitting element 103 is configured to allow the second beam L12 from the second light source module 102 to pass through and be transmitted to the optical element 190 along the second direction X. Therefore, the first beam L11 and/or the second beam L12 may be used as the illumination beam L1 and be transmitted to the light valve module 200 through the optical element 190. The first light splitting element 103 includes a first light splitting zone 1031 and a second light splitting zone 1032. The first light splitting zone 1031 and the second light splitting zone 1032 are arranged along the first extension direction D1. The first light splitting zone 1031 is configured to reflect the second sub beam 1012 and the third sub beam 1013 of the first beam L11 to transmit the second sub beam 1012 and the third sub beam 1013 of the first beam L11 to the optical element 190 along the second direction X and for allowing the first sub beam 1021 of the second beam L12 to pass through. The second light splitting zone 1032 is configured to reflect the first sub beam 1011 of the first beam L11 to transmit the first sub beam 1011 of the first beam L11 to the optical element 190 along the second direction X and for allowing the second sub beam 1022 and the third sub beam 1023 of the second beam L12 to pass through. The first light splitting zone 1031 is, for example, configured to reflect wavelengths below 580 nm and to allow wavelengths above 580 nm to pass through (as shown in FIG. 6). The second light splitting zone 1032 is, for example, configured to allow wavelengths below 580 nm to pass through and to reflect wavelengths above 580 nm (as shown in FIG. 7). The first light splitting zone 1031 is, for example, configured to allow the red light beam to pass through and to reflect the blue light beam and the green light beam. The second light splitting zone 1032 is, for example, configured to reflect the red light beam and to allow the blue light beam and the green light beam to pass through. The first light splitting element 103 is, for example, a beam splitter (e.g., a dichroic mirror). In one embodiment, the first light splitting zone 1031 and the second light splitting zone 1032 may be two different beam splitters. In another embodiment, the first light splitting zone 1031 and the second light splitting zone 1032 may be implemented by different coatings on different areas of the same beam splitter.

The first beam L11 and the second beam L12 form light spots on the optical element 190 that at least partially overlap. As shown in FIG. 8, when the light emitting unit R, the light emitting unit G and the light emitting unit B in the first light source module 101 and the second light source module 102 are all turned on, the light spot formed by the first sub beam 1011 of the first beam L11 on the optical element 190 at least partially overlaps with the light spots formed by the second sub beam 1022 and the third sub beam 1023 of the second beam L12 on the optical element 190 respectively to form a first light spot group P1. The light spot formed on the optical element 190 by the first sub beam 1021 of the second beam L12 at least partially overlaps with the light spots formed on the optical element 190 by the second sub beam 1012 and the third sub beam 1013 of the first beam L11 to form a second light spot group P2. The first light spot group P1 and the second light spot group P2 are arranged along the first direction Y.

As described above, the illumination system of one embodiment of the present disclosure allows the light spots formed by multiple beams on the optical element 190 to at least partially overlap. Therefore, the brightness of the illumination beam L1 is effectively improved, and the overall size of the light spots does not need to be increased, thereby achieving the effect of not increasing the volume of the projection device 1.

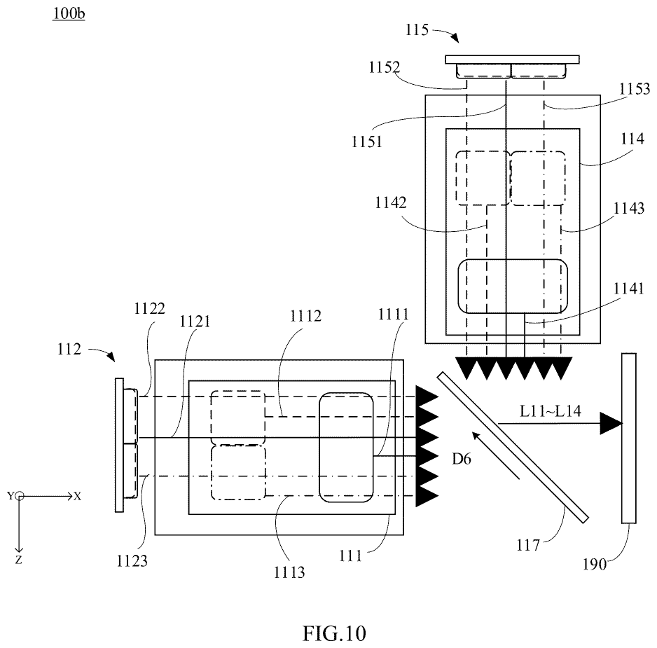

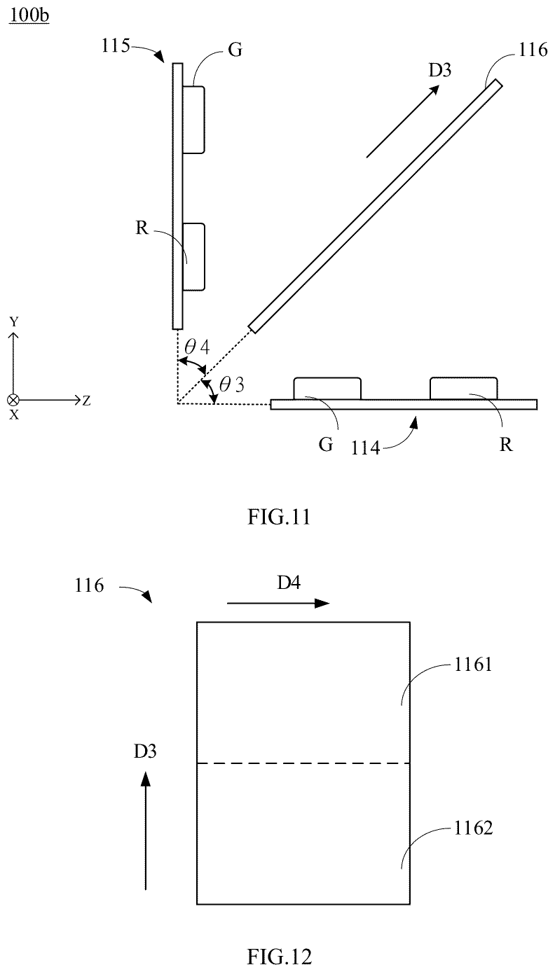

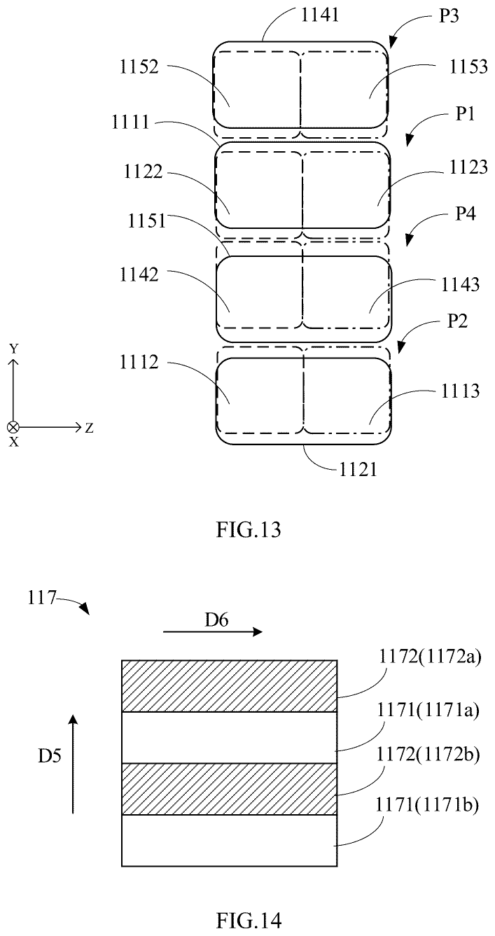

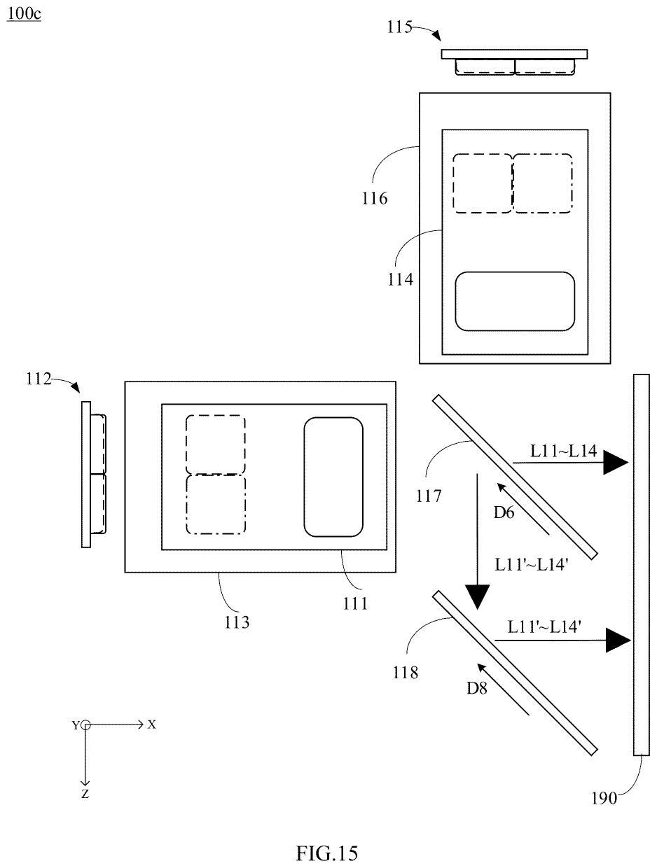

Please refer to FIG. 9 to FIG. 14. FIG. 9 and FIG. 10 are schematics of an illumination system according to an embodiment of the present disclosure. FIG. 11 is a schematic of a configuration example of the light splitting element according to an embodiment of the present disclosure. FIG. 12 is a schematic of the light splitting element according to an embodiment of the present disclosure. FIG. 13 is a schematic of light spots according to an embodiment of the present disclosure. FIG. 14 is a schematic of an optical element according to an embodiment of the present disclosure. The illumination system 100b includes a first light source module 111, a second light source module 112, a first light splitting element 113, a third light source module 114, a fourth light source module 115, a second light splitting element 116 and a first optical element 117. The illumination system 100b further includes an optical element 190. The components, operations and principles of the first light source module 111, the second light source module 112 and the first light splitting element 113 are the same as those of the first light source module 101, the second light source module 102 and the first light splitting element 103 described above and thus will not be described in detail herein.

The first light source module 111 is configured to generate a first beam L11 transmitted along the first direction Y. The first beam L11 includes at least one of a first sub beam 1111, a second sub beam 1112, and a third sub beam 1113. The second light source module 112 is configured to generate a second beam L12 transmitted along a second direction X. The second beam L12 includes at least one of a first sub beam 1121, a second sub beam 1122, and a third sub beam 1123.

The third light source module 114 includes a first light emitting unit R, a second light emitting unit G and a third light emitting unit B. The third light source module 114 is configured to provide a third beam L13 transmitted along the first direction Y. The third beam L13 includes at least one of a first sub beam 1141, a second sub beam 1142 and a third sub beam 1143.

The fourth light source module 115 includes a first light emitting unit R, a second light emitting unit G and a third light emitting unit B. The fourth light source module 115 is configured to provide a fourth beam L14 transmitted along the third direction Z. The fourth beam L14 includes at least one of a first sub beam 1151, a second sub beam 1152 and a third sub beam 1153.

The second light splitting element 116 is disposed between the third light source module 114 and the fourth light source module 115. The second light splitting element 116 is configured to reflect the third beam L13 to cause the third beam L13 to be transmitted to the first optical element 117 along the third direction Z. The second light splitting element 116 is configured to allow the fourth beam L14 to pass through and to be transmitted to the first optical element 117 along the third direction Z. The second light splitting element 116 may be the same as the first light splitting element 113. The second light splitting element 116 is disposed parallel to a third extension direction D3 and a fourth extension direction D4. The third extension direction D3 is, for example, a direction that is 45 degrees to the first direction Y and the third direction Z respectively. The fourth extension direction D4 is, for example, a direction parallel to the second direction X. An extension plane of the second light splitting element 116 and an extension plane of the third light source module 114 have an included angle θ3. An extending plane of the second light splitting element 116 and an extending plane of the fourth light source module 115 have an included angle θ4. The included angle θ3 and the included angle θ4 are, for example, 45 degrees. The second light splitting element 116 includes a first light splitting zone 1161 and a second light splitting zone 1162. The first light splitting zone 1161 and the second light splitting zone 1162 are arranged along the third extension direction D3. The first light splitting zone 1161 is configured to reflect the first sub beam 1141 of the third beam L13 to cause the first sub beam 1141 of the third beam L13 to be transmitted to the first optical element 117 along the third direction Z. The first light splitting zone 1161 allows the second sub beam 1152 and the third sub beam 1153 of the fourth beam L14 to pass through. The second light splitting zone 1162 is configured to reflect the second sub beam 1142 and the third sub beam 1143 of the third beam L13 to cause the second sub beam 1142 and the third sub beam 1143 of the third beam L13 to be transmitted to the first optical element 117 along the third direction Z. The second light splitting zone 1162 allows the first sub beam 1151 of the fourth beam L14 to pass through.

In the embodiment, the extension direction of the third light source module 114 is parallel to the second direction X and the third direction Z, and the extension direction of the fourth light source module 115 is parallel to the first direction Y and the second direction X. On a reference plane perpendicular to the second direction X, the third light source module 114 and the fourth light source module 115 are arranged in an L shape. The third light source module 114 and the fourth light source module 115 are symmetrically disposed with respect to the first light source module 111 and the second light source module 112, respectively, along a sixth extension direction D6 of the first optical element 117.

The first optical element 117 is disposed between the plurality of light source modules (111, 112, 114 and 115) and the optical element 190. The first optical element 117 is disposed parallel to a fifth extension direction D5 and the sixth extension direction D6. The fifth extension direction D5 is, for example, a direction parallel to the first direction Y. The sixth extension direction D6 is, for example, a direction oblique to the second direction X and the third direction Z respectively. The first optical element 117 is configured to allow at least a portion of the first beam L11 and a portion of the second beam L12 from the first light source module 111 and the second light source module 112 to pass through. The first optical element 117 is configured to reflect at least a portion of the third beam L13 and a portion of the fourth beam L14 from the third light source module 114 and the fourth light source module 115 respectively. The first optical element 117 transmits the first beam L11, the second beam L12, the third beam L13, and the fourth beam L14 along the second direction X to the optical element 190. In the embodiment, the first optical element 117 is configured to allow the first beam L11 and the second beam L12 to pass through and is configured to reflect the third beam L13 and the fourth beam L14. The first optical element 117 transmits the first beam L11, the second beam L12, the third beam L13 and the fourth beam L14 along the second direction X to the optical element 190. The first optical element 117 is, for example, a zoned optical element. The zoned optical element includes a plurality of transmissive zones 1171 (1171a, 1171b) and a plurality of reflection zones 1172 (1172a, 1172b). The plurality of transmissive zones 1171 and the plurality of reflection zones 1172 are arranged alternately along the fifth extension direction D5. The transmissive zone 1171a is configured to allow the first sub beam 1111 of the first beam L11, the second sub beam 1122 and the third sub beam 1123 of the second beam L12 to pass through. The transmissive zone 1171b is configured to allow the second sub beam 1112, the third sub beam 1113 of the first beam L11 and the first sub beam 1121 of the second beam L12 to pass through. The reflection zone 1172a is configured to reflect the first sub beam 1141 of the third beam L13, the second sub beam 1152 and the third sub beam 1153 of the fourth beam L14. The reflection zone 1172b is configured to reflect the second sub beam 1142 and the third sub beam 1143 of the third beam L13 and the first sub beam 1151 of the fourth beam L14. The transmissive zone 1171 of the zoned optical element may be a light-transmitting member made of materials such as resin glass or plastic, or may be air. The reflection zone 1172 of the zoned optical element may be, for example, a mirror plate having a reflective layer coating or may be a reflective mirror.

The first beam L11, the second beam L12, the third beam L13 and/or the fourth beam L14 may be used as the illumination beam L1 and transmitted to the light valve module 200 through the optical element 190. The first beam L11, the second beam L12, the third beam L13, and the fourth beam L14 form light spots on the optical element 190 that at least partially overlap. As shown in FIG. 13, when the first light emitting unit R, the second light emitting unit G and the third light emitting unit B in the first light source module 111, the second light source module 112, the third light source module 114 and the fourth light source module 115 are all turned on, the light spots formed by the first sub beam 1111 of the first beam L11 on the optical element 190 at least partially overlap with the light spots formed by the second sub beam 1122 and the third sub beam 1123 of the second beam L12 on the optical element 190 to form a first light spot group P1. The light spots formed by the first sub beam 1121 of the second beam L12 on the optical element 190 at least partially overlap with the light spots formed by the second sub beam 1112 and the third sub beam 1113 of the first beam L11 on the optical element 190 to form a second light spot group P2. The light spots formed by the first sub beam 1141 of the third beam L13 on the optical element 190 at least partially overlap with the light spots formed by the second sub beam 1152 and the third sub beam 1153 of the fourth beam L14 on the optical element 190 to form a third light spot group P3. The light spots formed by the first sub beam 1151 of the fourth beam L14 on the optical element 190 at least partially overlap with the light spots formed by the second sub beam 1142 and the third sub beam 1143 of the third beam L13 on the optical element 190 to form a fourth light spot group P4. The first light spot group P1, the second light spot group P2, the third light spot group P3 and the fourth light spot group P4 are alternately arranged in the first direction Y. The second light spot group P2, the fourth light spot group P4, the first light spot group P1 and the third light spot group P3 are arranged in sequence along the first direction Y.

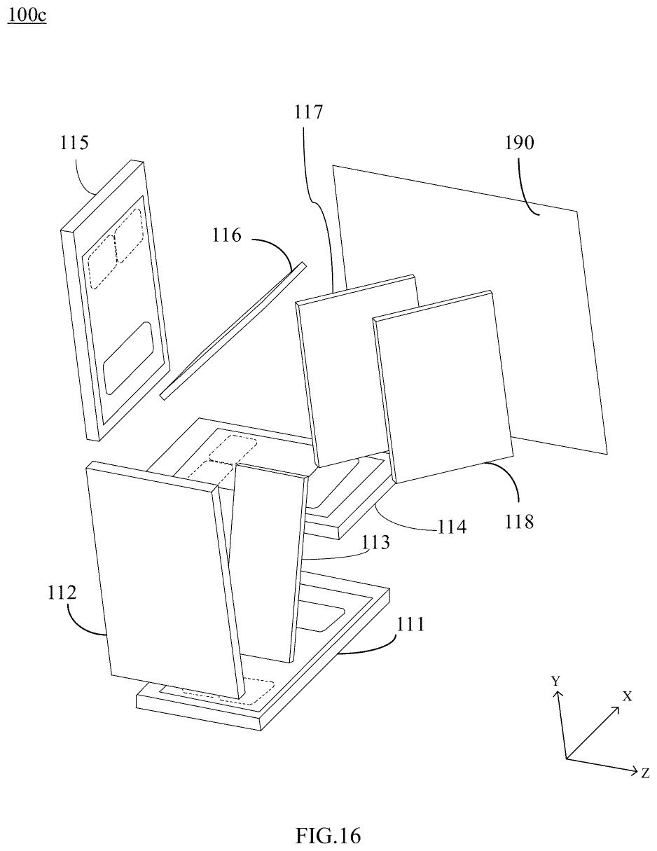

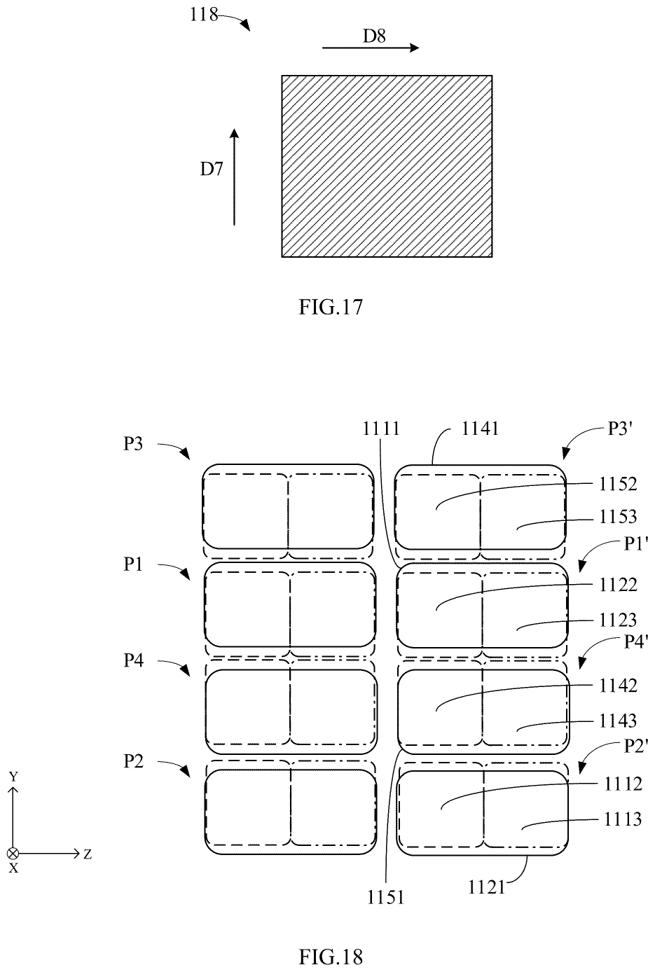

Please refer to FIG. 15 to FIG. 18. FIG. 15 is a schematic of an illumination system according to an embodiment of the present disclosure. The difference between the embodiments of FIG. 15 and FIG. 9 is that the illumination system 100c further includes a second optical element 118. In the second direction X, the second optical element 118 is disposed between the first light source module 111, the second light source module 112 and the optical element 190. The second optical element 118 and the first optical element 117 are disposed along the third direction Z. The second optical element 118 is, for example, a reflective mirror. The second optical element 118 is disposed parallel to a seventh extension direction D7 and an eighth extension direction D8. The seventh extension direction D7 is, for example, a direction parallel to the first direction Y. The eighth extension direction D8 is, for example, a direction parallel to the sixth extension direction D6. In the embodiment, the first optical element 117 is a partially transmissive and partially reflective optical element. The partially transmissive and partially reflective optical element is, for example, a beam splitter or a partially transmissive and partially reflective mirror. The partially transmissive and partially reflective optical element is configured to allow portions of the first beam L11, the second beam L12, the third beam L13′ and the fourth beam L14′ to pass through. The partially transmissive and partially reflective optical element is configured to reflect the other portions of the first beam L11′, the second beam L12′, the third beam L13 and the fourth beam L14. The other portions of the first beam L11′ and the second beam L12′ and portions of the third beam L13′ and the fourth beam L14′ are transmitted to the second optical element 118. In one embodiment, the partially transmissive and partially reflective optical element has a transmittance and reflectance of approximately 50% and 50%. In another embodiment, the transmittance and reflectance may also be in other ratios, such as 30%/70%, 40%/60%, or other applicable combinations. The second optical element 118 is disposed on the transmission path of a portion of the third beam L13′ and a portion of the fourth beam L14′ from the first optical element 117 and is disposed on the transmission path of the other portions of the first beam L11′ and the second beam L12′ from the first optical element 117. The second optical element 118 is configured to reflect the other portions of the first beam L11′ and the second beam L12′ and portions of the third beam L13″ and the fourth beam L14′ to cause the other portions of the first beam L11′ and the second beam L12′ and portions of the third beam L13′ and the fourth beam L14′ to be transmitted to the optical element 190.

According to the above, the first beam L11, the second beam L12, the third beam L13 and/or the fourth beam L14 may be used as the illumination beam L1 and transmitted to the light valve module 200 through the optical element 190. The first beam L11 and the second beam L12, and the third beam L13 and the fourth beam L14, form light spots on the optical element 190 that at least partially overlap. As shown in FIG. 18, when the first light emitting unit R, the second light emitting unit G and the third light emitting unit B in the first light source module 111, the second light source module 112, the third light source module 114 and the fourth light source module 115 are all turned on, the light spots formed on the optical element 190 by the first sub beam 1111 (i.e., a portion of the first beam L11) at least partially overlap with the light spots formed on the optical element 190 by the second sub beam 1122 and the third sub beam 1123 (i.e., a portion of the second beam L12) to form a light spot group P1. The light spots formed on the optical element 190 by the first sub beam 1121 (i.e., a portion of the second beam L12) at least partially overlap with the light spots formed on the optical element 190 by the second sub beam 1112 and the third sub beam 1113 (i.e., a portion of the first beam L11) to form a light spot group P2. The light spots formed on the optical element 190 by the first sub beam 1141 (i.e., the other portion of the third beam L13) at least partially overlap with the light spots formed on the optical element 190 by the second sub beam 1152 and the third sub beam 1153 (i.e., the other portion of the fourth beam L14) to form a third light spot group P3. The light spots formed on the optical element 190 by the first sub beam 1151 (i.e., the other portion of the fourth beam L14) at least partially overlap with the light spots formed on the optical element 190 by the second sub beam 1142 and the third sub beam 1143 (i.e., the other portion of the third beam L13) to form a fourth light spot group P4. The first light spot group P1, the second light spot group P2, the third light spot group P3 and the fourth light spot group P4 are alternately arranged in the first direction Y. The third light spot group P3, the first light spot group P1, the fourth light spot group P4 and the second light spot group P2 are arranged in sequence along the first direction Y. The light spots formed on the optical element 190 by the first sub beam 1111 (i.e., the other portion of the first beam L11′) at least partially overlap with the light spots formed on the optical element 190 by the second sub beam 1122 and the third sub beam 1123 (i.e., the other portion of the second beam L12′) to form a first sub light spot group P1′. The light spots formed on the optical element 190 by the first sub beam 1121 (i.e., the other portion of the second beam L12 at least partially overlap with the light spots formed on the optical element 190 by the second sub beam 1112 and the third sub beam 1113 (i.e., the other portion of the first beam L11) to form a second sub light spot group P2′. The light spots formed on the optical element 190 by the first sub beam 1141 (i.e., the portion of the third beam L13′) at least partially overlap with the light spots formed on the optical element 190 by the second sub beam 1152 and the third sub beam 1153 (i.e., the portion of the fourth beam L14′) to form a third sub light spot group P3″. The light spots formed on the optical element 190 by the first sub beam 1151 (i.e., the portion of the fourth beam L14) at least partially overlap with the light spots formed on the optical element 190 by the second sub beam 1142 and the third sub beam 1143 (i.e., the portion of the third beam L13′) to form a fourth sub light spot group P4′. The first sub-light spot group P1′, the second sub-light spot group P2′, the third sub-light spot group P3′ and the fourth sub-light spot group P4 are alternately arranged in the first direction Y. The second sub-light spot group P2′, the fourth sub-light spot group P4′, the first sub-light spot group P1′ and the third sub-light spot group P3′ are arranged in sequence along the first direction Y. The first light spot group P1, the second light spot group P2, the third light spot group P3 and the fourth light spot group P4 are arranged along the third direction Z in alignment with the first sub-light spot group P1′, the second sub-light spot group P2′, the third sub-light spot group P3′ and the fourth sub-light spot group P4′, respectively.

According to the above, the first beam L11, the second beam L12, the third beam L13 and the fourth beam L14 may be dispersed to the first light spot group P1, the second light spot group P2, the third light spot group P3 and the fourth light spot group P4 corresponding to the first optical element 117 and the first sub-light spot group P1′, the second sub-light spot group P2′, the third sub-light spot group P3′ and the fourth sub-light spot group P4′ corresponding to the second optical element 118. In this way, the concentration of beam energy in a specific area of the optical element 190, which may otherwise induce a thermal lensing can be avoided, and the utilization rate of the optical element 190 may be effectively improved. Thereby, the effect of increasing the life and use efficiency of the optical element 190 is achieved.

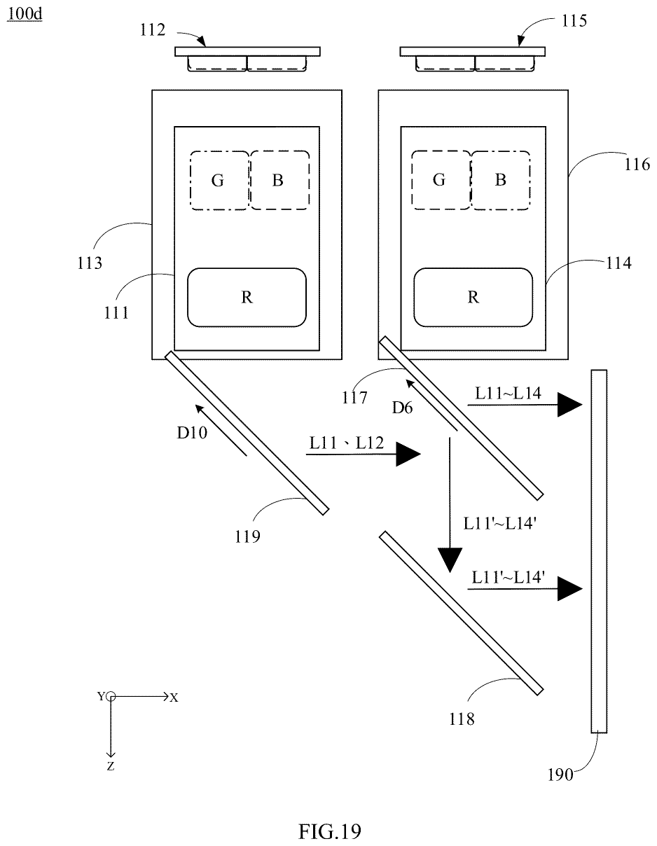

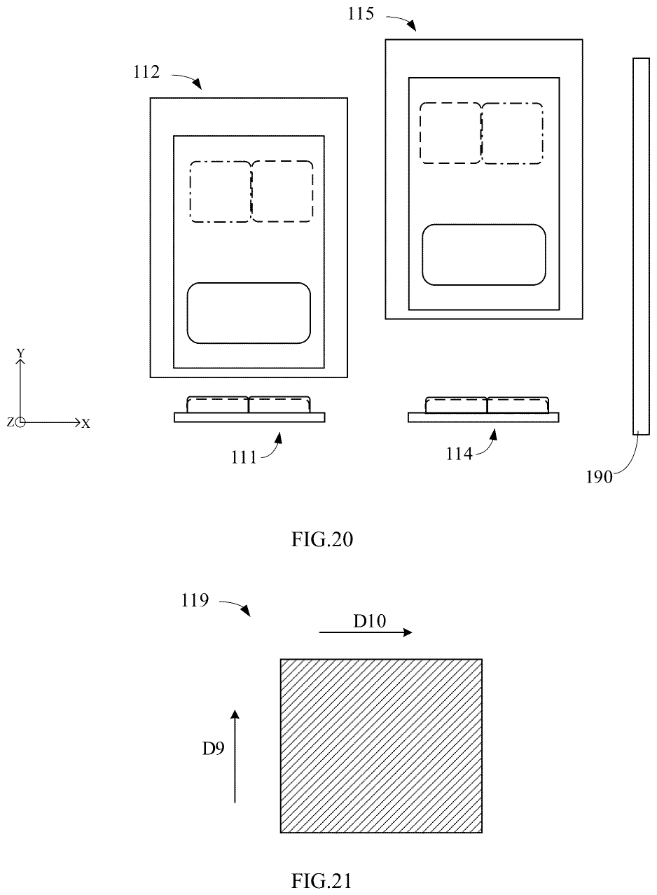

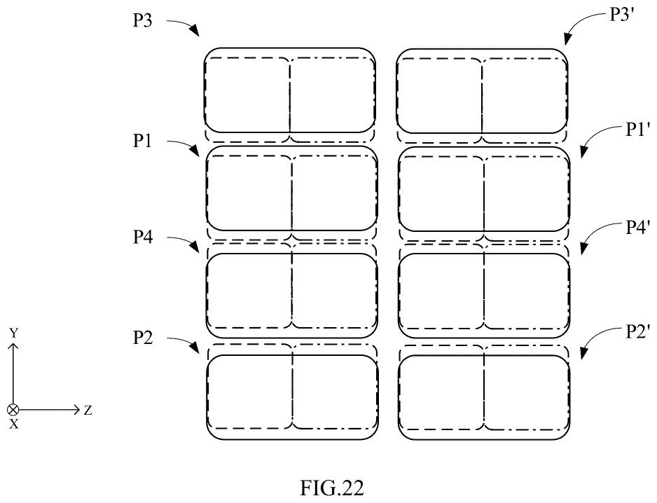

Please refer to FIG. 19 to FIG. 22. FIG. 19 is a schematic of an illumination system according to an embodiment of the present disclosure. FIG. 20 is a partial schematic of the embodiment of FIG. 19. FIG. 21 is a schematic of an optical element according to an embodiment of the present disclosure. FIG. 22 is a schematic of light spots according to an embodiment of the present disclosure. The difference between the embodiments of FIG. 19 and FIG. 15 is that the first light source module 111 and the second light source module 112 of the illumination system 100d are disposed in parallel with the third light source module 114 and the fourth light source module 115 along the second direction X, respectively. The illumination system 100d further includes a third optical element 119. The first light source module 111 provides a first beam L11 transmitted along the first direction Y. The second light source module 112 provides a second beam L12 transmitted along the third direction Z. In the embodiment, the configurations of the first light emitting unit R, the second light emitting unit G, and the third light emitting unit B of the first light source module 111 are the same as those of the first light emitting unit R, the second light emitting unit G, and the third light emitting unit B of the third light source module 114. The configurations of the first light emitting unit R, the second light emitting unit G and the third light emitting unit B of the second light source module 112 are the same as those of the first light emitting unit R, the second light emitting unit G and the third light emitting unit B of the fourth light source module 115. In another embodiment, the first light emitting unit R, the second light emitting unit G and the third light emitting unit B of the first light source module 111 are arranged inversely with the first light emitting unit R, the second light emitting unit G and the third light emitting unit B of the third light source module 114 in the third direction Z. The first light emitting unit R, the second light emitting unit G and the third light emitting unit B of the second light source module 112 are arranged such that they are inverted to the first light emitting unit R, the second light emitting unit G and the third light emitting unit B of the fourth light source module 115 in the first direction Y. The first light emitting unit R of the first light source module 111 is farther away from the third optical element 119 than are the second light emitting unit G and the third light emitting unit B. The first light emitting unit R of the second light source module 112 is farther away from the first light source module 111 than are the second light emitting unit G and the third light emitting unit B. The first light splitting element 113 is configured to reflect the first beam L11 and allow the second beam L12 to pass through. The first light splitting element 113 transmits the first beam L11 and the second beam L12 to the third optical element 119 along the third direction Z. In the embodiment, the second light source module 112 and the fourth light source module 115 are dislocated from each other in the first direction Y. Thus, the main beams of the first beam L11 and the second beam L12 transmitted toward the optical element 190 do not overlap with the main beams of the third beam L13 and the fourth beam L14.

The third optical element 119 and the first optical element 117 are arranged along the second direction X. The third optical element 119 is disposed parallel to a ninth extension direction D9 and a tenth extension direction D10. The ninth extension direction D9 is, for example, a direction parallel to the first direction Y. The tenth extension direction D10 is, for example, a direction parallel to the sixth extension direction D6. The third optical element 119 is configured to reflect the first beam L11 from the first light source module 111 and the second beam L12 from the second light source module 112 to cause the first beam L11 and the second beam L12 to be transmitted to the first optical element 117 along the second direction X. The third optical element 119 is, for example, a reflective mirror. The first optical element 117 and the second optical element 118 are the same as those in the embodiment of FIG. 12 and thus are not described again herein. The first beam L11, the second beam L12, the third beam L13 and/or the fourth beam L14 may be used as the illumination beam L1. As shown in FIG. 22, when the first light emitting unit R, the second light emitting unit G and the third light emitting unit B in the first light source module 111, the second light source module 112, the third light source module 114 and the fourth light source module 115 are all turned on, the first beam L11, the second beam L12, the third beam L13 and the fourth beam L14 may form a first light spot group P1, a second light spot group P2, a third light spot group P3, a fourth light spot group P4, a first sub-light spot group P1′, a second sub-light spot group P2′, a third sub-light spot group P3′ and a fourth sub-light spot group P4 on the optical element 190, respectively. The compositions of the first light spot group P1, the second light spot group P2, the third light spot group P3, the fourth light spot group P4, the first sub light spot group P1′, the second sub light spot group P2″, the third sub light spot group P3′ and the fourth sub light spot group P4 are the same as those in the embodiment of FIG. 18 and are not described again herein.

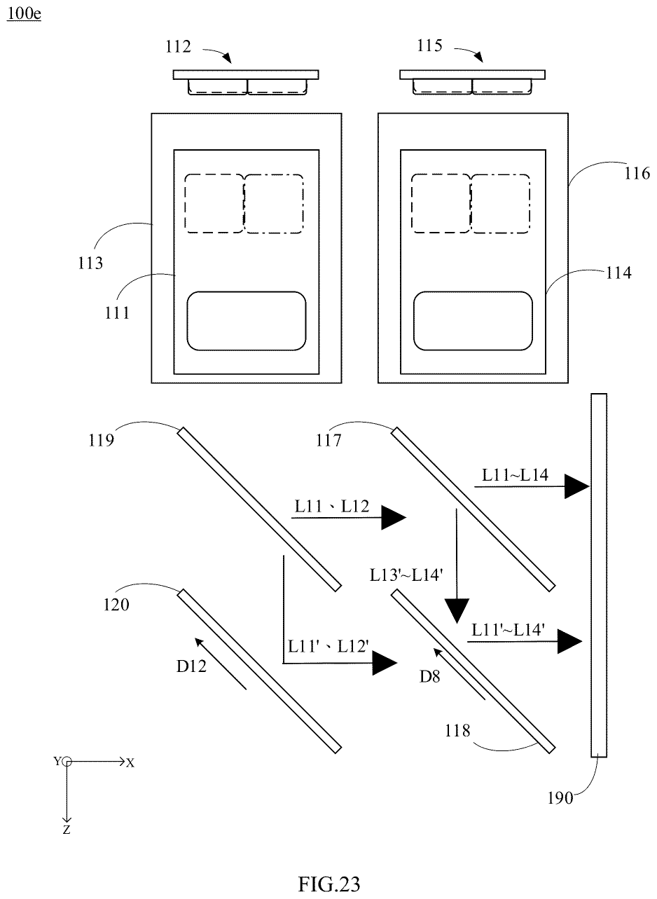

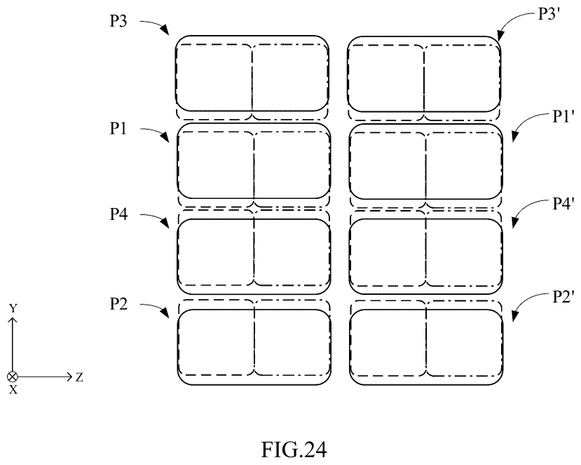

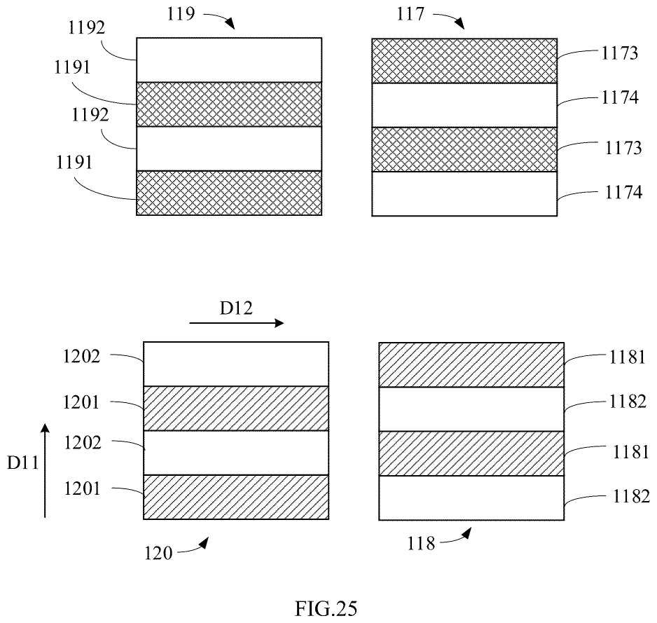

Please refer to FIG. 23 to FIG. 25. FIG. 23 is a schematic of an illumination system according to an embodiment of the present disclosure. FIG. 24 is a schematic of light spots according to an embodiment of the present disclosure. FIG. 25 is a schematic of an optical element according to an embodiment of the present disclosure. The difference between the embodiments of FIG. 23 and FIG. 19 is that the illumination system 100e further includes a fourth optical element 120. In the embodiment, the third optical element 119 is configured to allow a first portion of the first beam L11′ and a first portion of the second beam L12′ to pass through and be transmitted to the fourth optical element 120. The third optical element 119 is also configured to reflect a second portion of the first beam L11 and a second portion of the second beam L12 and transmit them to the first optical element 117. The fourth optical element 120 and the second optical element 118 are arranged along the second direction X. The fourth optical element 120 is disposed parallel to an eleventh extension direction D11 and a twelfth extension direction D12. The eleventh extension direction D11 is, for example, a direction parallel to the first direction Y. The twelfth extension direction D12 is, for example, a direction parallel to the eighth extension direction D8. The fourth optical element 120 is configured to reflect the first portion of the first beam L11′ and the first portion of the second beam L12′ to transmit the first portion of the first beam L11′ and the first portion of the second beam L12′ to the second optical element 118. The first optical element 117 is configured to allow a first portion of the third beam L13′ and a first portion of the fourth beam L14′ to pass through and is configured to reflect a second portion of the third beam L13 and a second portion of the fourth beam L14. The first optical element 117 is configured to allow a second portion of the first beam L11 and a second portion of the second beam L12 from the third optical element 119 to pass through. The second optical element 118 is configured to allow the first portions of the first beam L11′ and the second beam L12′ from the fourth optical element 120 to pass through and reflect the first portions of the third beam L13′ and the fourth beam L14′ from the first optical element 117.

In the embodiment, the first optical element 117 includes at least one partially reflective zone 1173. For example, the first optical element 117 includes a plurality of partially reflective zones 1173 and a plurality of transmissive zones 1174. The plurality of partially reflective zones 1173 and the plurality of transmissive zones 1174 are alternately arranged. The plurality of partially reflective zones 1173 are configured to allow the first portion of the third beam L13′ and the first portion of the fourth beam L14′ to pass through and to reflect the second portion of the third beam L13 and the second portion of the fourth beam L14. The plurality of transmissive zones 1174 are configured to allow the second portion of the first beam L11 and the second portion of the second beam L12 from the third optical element 119 to pass through. In the embodiment, the second optical element 118 includes a plurality of reflection zones 1181 and a plurality of transmissive zones 1182. The plurality of reflection zones 1181 and the plurality of transmissive zones 1182 of the second optical element 118 are alternately arranged. In one embodiment, the third optical element 119 includes at least one partially reflective zone, and the at least one partially reflective zone is arranged on a transmission path of the first beam L11 and the second beam L12 from the first light splitting element 113. The third optical element 119 includes a plurality of partially reflective zones 1191 and a plurality of transmissive zones 1192. The plurality of partially reflective zones 1191 are configured to allow the first portion of the first beam L11′ and the first portion of the second beam L12′ to pass through and are configured to reflect the first beam L1l and the second beam L12 of the second part. In one embodiment, the third optical element 119 and the first optical element 117 may be the same component, and the only difference between the two is the different configuration directions. In another embodiment, the third optical element 119 may have only one partially reflective zone. The third optical element 119 is, for example, a partially transmissive and partially reflective optical element (beam splitter) partially transmissive and partially reflective. In one embodiment, the fourth optical element 120 includes at least one reflection zone. The fourth optical element 120 includes a plurality of reflection zones 1201 and a plurality of transmissive zones 1202. The plurality of reflection zones 1201 are configured to reflect the first portion of the first beam L11′ and the first portion of the second beam L12′. In one embodiment, the fourth optical element 120 and the second optical element 118 may be the same component, and the only difference between the two is the different configuration directions. In another embodiment, the fourth optical element 120 is, for example, a reflective mirror.

The first beam L11, the second beam L12, the third beam L13 and/or the fourth beam L14 may be used as the illumination beam L1. As shown in FIG. 24, when the first light emitting unit R, the second light emitting unit G and the third light emitting unit B in the first light source module 111, the second light source module 112, the third light source module 114 and the fourth light source module 115 are all turned on, the light spots of the first beam L11, the second beam L12, the third beam L13 and the fourth beam L14 form a first light spot group P1, a second light spot group P2, a third light spot group P3, a fourth light spot group P4, a first sub-light spot group P1″, a second sub-light spot group P2″, a third sub-light spot group P3′ and a fourth sub-light spot group P4′ on the optical element 190. The configurations of the first light spot group P1, the second light spot group P2, the third light spot group P3, the fourth light spot group P4, the first sub light spot group P1′, the second sub light spot group P2″, the third sub light spot group P3′ and the fourth sub light spot group P4 are the same as those in the embodiment of FIG. 18, so they are not repeated here.

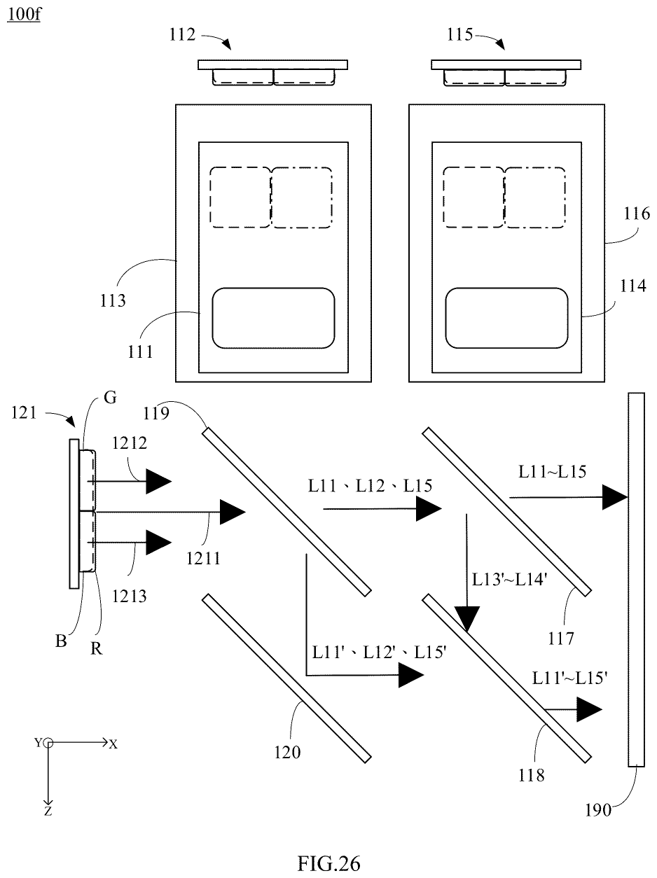

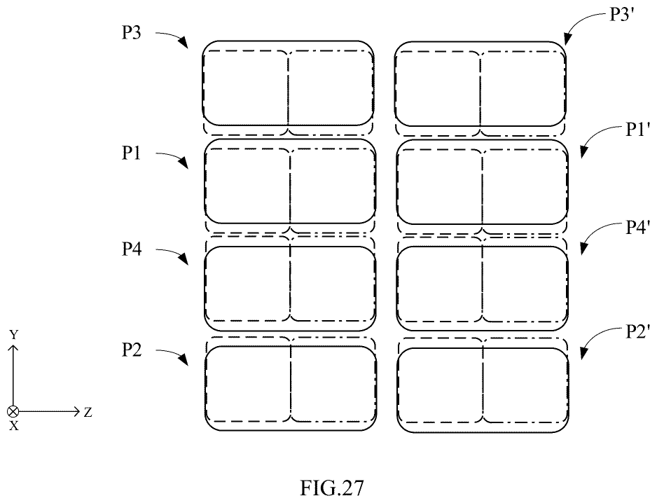

Please refer to FIG. 26 to FIG. 27. FIG. 26 is a schematic of an illumination system according to an embodiment of the present disclosure. FIG. 27 is a schematic of light spots according to an embodiment of the present disclosure. The difference between the embodiments of FIG. 26 and FIG. 23 is that the illumination system 100f further includes a fifth light source module 121. The fifth light source module 121 includes a first light emitting unit R, a second light emitting unit G and a third light emitting unit B, as shown in FIG. 4. The fifth light source module 121 is configured to provide a fifth beam L15. The fifth beam L15 includes at least one of a first sub beam 1211, a second sub beam 1212, and a third sub beam 1213. In the embodiment, at least one partially reflective zone of the third optical element 119 is disposed on the transmission path of the fifth beam L15 from the fifth light source module 121. The third optical element 119 is configured to reflect at least a portion of the fifth beam L15′ such that the portion of the fifth beam L15′ is transmitted to the fourth optical element 120. The third optical element 119 is further configured to allow the other portion of the fifth beam L15 to pass through such that the other portion of the fifth beam L15 is transmitted to the first optical element 117. In this embodiment, a transmission path of the portion of the fifth beam L15′ reflected by the third optical element 119, the first portion of the first beam L11′ and the first portion of the second beam L12′ passing through the third optical element 119 overlap. The transmission path of the other portion of the fifth beam L15 passing through the third optical element 119, the second portion of the first beam L11 and second portion of the second beam L12 reflected by the third optical element 119 overlap.

In this embodiment, the light spots formed by the first sub beam 1011 of the second portion of the first beam L11 on the optical element 190 at least partially overlap with the light spots formed by the second sub beam 1022 and the third sub beam 1023 of the second portion of the second beam L12 and the second sub beam 1212 and the third sub beam 1213 of the other portion of the fifth beam L15 on the optical element 190 to form a first light spot group P1. The light spots formed on the optical element 190 by the second sub beam 1012 and the third sub beam 1013 of the second portion of the first beam L11 at least partially overlap with the light spots formed on the optical element 190 by the first sub beam 1021 of the second portion of the second beam L12 and the first sub beam 1211 of the other portion of the fifth beam L15 to form a second light spot group P2. The light spots formed by the first sub beam 1011 of the first portion of the first beam L11′ on the optical element 190 at least partially overlap with the light spots formed by the second sub beam 1022 and the third sub beam 1023 of the first portion of the second beam L12′ and the second sub beam 1212 and the third sub beam 1213 of the portion of the fifth beam L15′ on the optical element 190 to form a first sub light spot group P1′. The light spots formed on the optical element 190 by the second sub beam 1012 and the third sub beam 1013 of the first portion of the first beam L11′ respectively at least partially overlap with the light spots formed on the optical element 190 by the first sub beam 1021 of the first portion of the second beam L12′ and the first sub beam 1211 of the portion of the fifth beam L15′ to form a second sub light spot group P2″. In the embodiment, the first optical element 117, the second optical element 118, the third optical element 119 and the fourth optical element 120 are the same as those in the embodiment of FIG. 20 and thus are not described again herein.

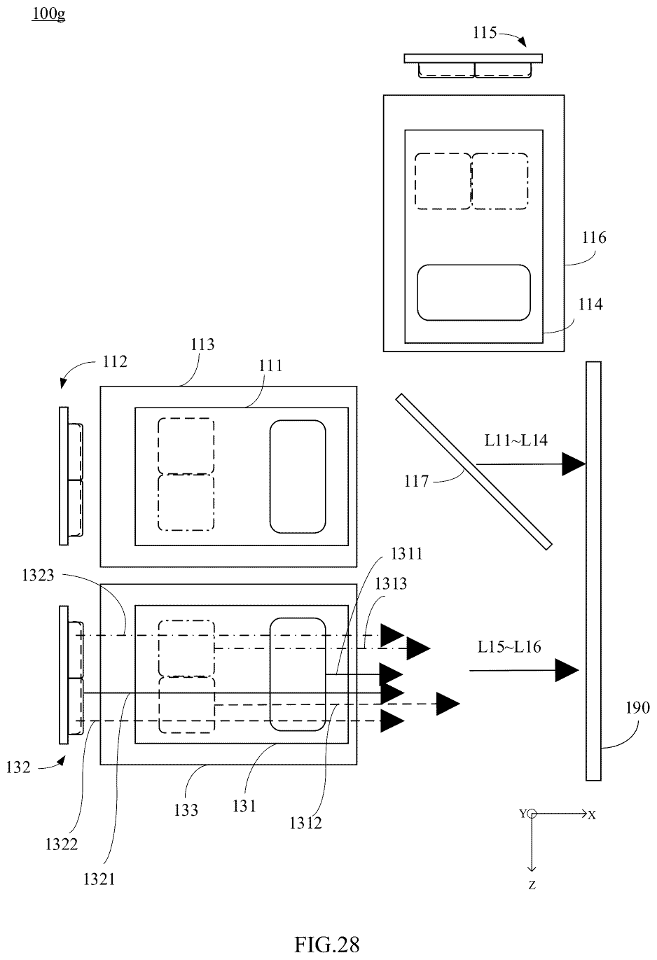

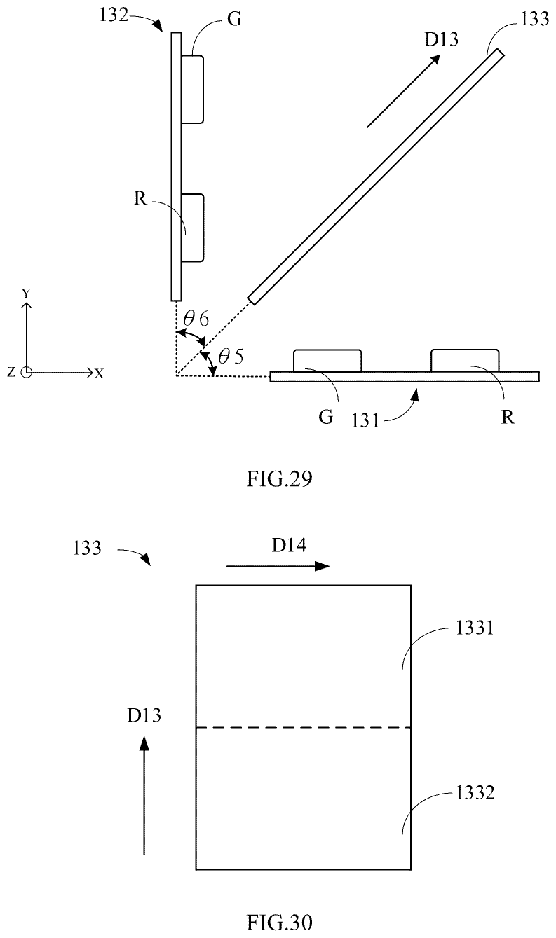

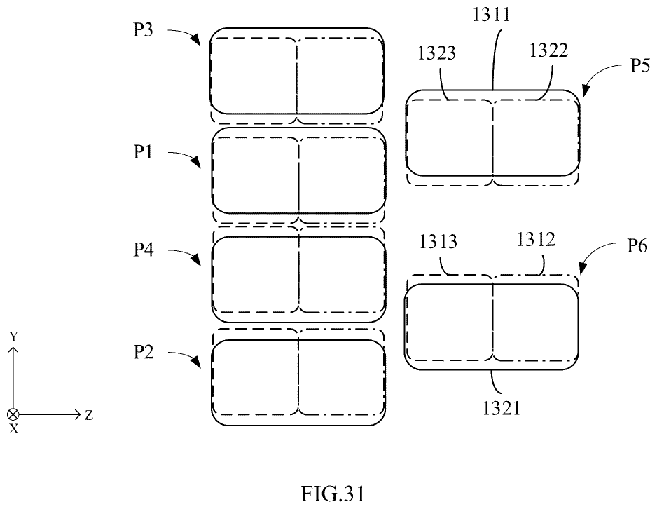

Please refer to FIG. 28 to FIG. 31. FIG. 28 is a schematic of an illumination system according to an embodiment of the present disclosure. FIG. 29 is a schematic of a configuration example of a light splitting element according to an embodiment of the present disclosure. FIG. 30 is a schematic of a light splitting element according to an embodiment of the present disclosure. FIG. 31 is a schematic of light spots according to an embodiment of the present disclosure. The difference between the embodiments of FIG. 28 and FIG. 9 is that the illumination system 100g includes a fifth light source module 131, a sixth light source module 132 and a third light splitting element 133. The fifth light source module 131 and the sixth light source module 132 are respectively disposed in parallel with the first light source module 111 and the second light source module 112 in the third direction Z. The fifth light source module 131 is configured to provide a fifth beam L15 transmitted along the first direction Y. The sixth light source module 132 is configured to provide a sixth beam L16 transmitted along the second direction X. The fifth light source module 131 includes a first light emitting unit R, a second light emitting unit G and a third light emitting unit B. The fifth beam L15 includes a first sub beam 1311, a second sub beam 1312 and a third sub beam 1313. The sixth light source module 132 includes a first light emitting unit R, a second light emitting unit G and a third light emitting unit B. The sixth beam L16 includes a first sub beam 1321, a second sub beam 1322 and a third sub beam 1323. The third light splitting element 133 is disposed between the fifth light source module 131 and the sixth light source module 132. The third light splitting element 133 is configured to reflect the fifth beam L15 and allowing the sixth beam L16 to pass through such that the fifth beam L15 and the sixth beam L16 are transmitted to the optical element 190. In the embodiment, the third light splitting element 133 and the first light splitting element 113 may be the same element. The third light splitting element 133 is disposed parallel to a thirteenth extension direction D13 and a fourteenth extension direction D14. The thirteenth extension direction D13 is, for example, a direction that is 45 degrees to the first direction Y and the second direction X, respectively. The fourteenth extension direction D14 is, for example, a direction parallel to the third direction Z. An extending plane of the third light splitting element 133 and an extending plane of the fifth light source module 131 form an included angle θ5. An extending plane of the third light splitting element 133 and an extending plane of the sixth light source module 132 form an included angle θ6. The included angle θ5 and the included angle θ6 are, for example, 45 degrees. The third light splitting element 133 includes a first light splitting zone 1331 and a second light splitting zone 1332. The first light splitting zone 1331 and the second light splitting zone 1332 are arranged along the thirteenth extension direction D13. The first light splitting zone 1331 is configured to reflect the first sub beam 1311 of the fifth beam L15 such that the first sub beam 1311 of the fifth beam L15 is transmitted to the optical element 190 along the second direction X. The first light splitting zone 1331 is configured to allow the second sub beam 1322 and the third sub beam 1323 of the sixth beam L16 to pass through. The second light splitting zone 1332 is configured to reflect the second sub beam 1312 and the third sub beam 1313 of the fifth beam L15 such that the second sub beam 1312 and the third sub beam 1313 of the fifth beam L15 are transmitted to the optical element 190 along the second direction X. The second light splitting zone 1332 allows the first sub beam 1321 of the sixth light beam L16 to pass through. The plurality of light spots of the fifth beam L15 and the plurality of light spots of the sixth beam L16 at least partially overlap on the optical element 190 to form a fifth light spot group P5 and a sixth light spot group P6.

In the embodiment, the light spots formed by the first sub beam 1311 of the fifth beam L15 on the optical element 190 at least partially overlap with the light spots formed by the second sub beam 1322 and the third sub beam 1323 of the sixth beam L16 on the optical element 190 to form a fifth light spot group P5. The light spots formed by the first sub beam 1321 of the sixth beam L16 on the optical element 190 at least partially overlap with the light spots formed by the second sub beam 1312 and the third sub beam 1313 of the fifth beam L15 on the optical element 190 to form a sixth light spot group P6. The fifth light spot group P5 and the sixth light spot group P6 are arranged along the first direction Y. The fifth light spot group P5 is located between the first light spot group P1 and the third light spot group P3 in the first direction Y. The sixth light spot group P6 is located between the second light spot group P2 and the fourth light spot group P4 in the first direction Y. The fifth light spot group P5 and the sixth light spot group P6 are arranged along the third direction Z with the first light spot group P1, the second light spot group P2, the third light spot group P3 and the fourth light spot group P4.

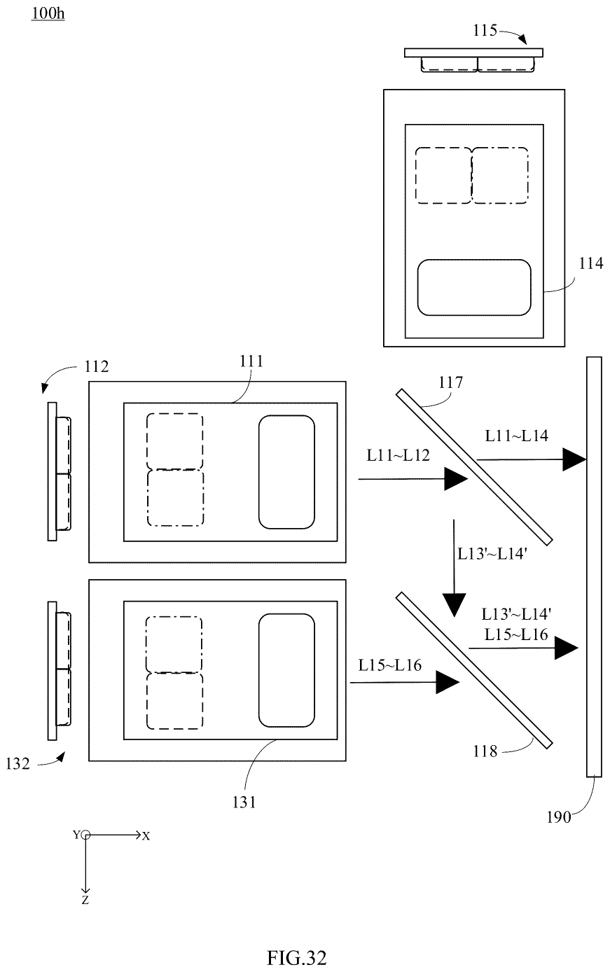

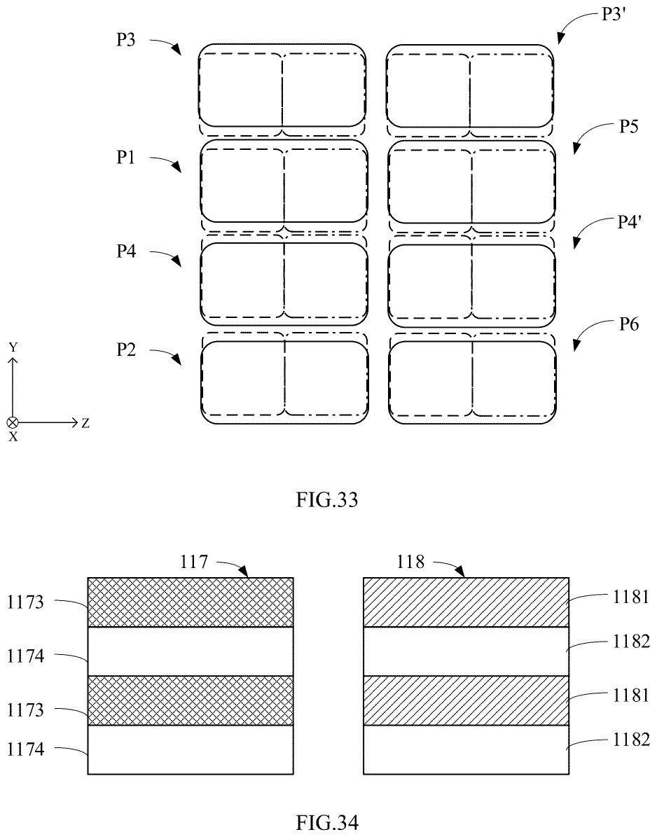

Please refer to FIG. 32 to FIG. 34. FIG. 32 is a schematic of an illumination system according to an embodiment of the present disclosure. FIG. 33 is a schematic of light spots according to an embodiment of the present disclosure. FIG. 34 is a schematic of an optical element according to an embodiment of the present disclosure. The difference between the embodiments of FIG. 32 and FIG. 28 is that the illumination system 100h includes a second optical element 118. In the embodiment, the first optical element 117 is configured to allow a portion of the third beam L13′ and a portion of the fourth beam L14′ to pass through such that the portion of the third beam L13′ and the portion of the fourth beam L14′ are transmitted to the second optical element 118. The first optical element 117 is configured to reflect the other portions of the third beam L13 and the fourth beam L14 such that the other portions of the third beam L13 and the fourth beam L14 are transmitted to the optical element 190. The second optical element 118 is configured to allow the fifth beam L15 and the sixth beam L16 to pass through and to reflect the portions of the third beam L13′ and the fourth beam L14′ such that the portion of the third beam L13″, the portion of the fourth beam L14′, the fifth beam L15 and the sixth beam L16 are transmitted to the optical element 190. In this embodiment, the light spots formed by the first sub beam 1141 of the portion of the third beam L13′ on the optical element 190 at least partially overlap with the light spots formed by the second sub beam 1152 and the third sub beam 1153 of the portion of the fourth beam L14′ on the optical element 190 to form a third sub light spot group P3′. The light spots formed by the first sub beam 1151 of the portion of the fourth beam L14′ on the optical element 190 at least partially overlap with the light spots formed by the second sub beam 1142 and the third sub beam 1143 of the portion of the third beam L13′ on the optical element 190 to form a fourth sub light spot group P4′.

In this embodiment, the first optical element 117 includes a plurality of partially reflective zones 1173 and a plurality of transmissive zones 1174. The plurality of partially reflective zones 1173 and the plurality of transmissive zones 1174 are alternately arranged. The plurality of partially reflective zones 1173 are configured to reflect the other portions of the third beam L13 and the fourth beam L14 such that the other portions of the third beam L13 and the fourth beam L14 are transmitted to the optical element 190. The plurality of partially reflective zones 1173 are configured to allow the portion of the third beam L13′ and the portion of the fourth beam L14 to pass through. The plurality of transmissive zones 1174 are configured to allow the first beam L1l and the second beam L12 to pass through. The second optical element 118 includes a plurality of reflection zones 1181 and a plurality of transmissive zones 1182. The plurality of reflection zones 1181 and the plurality of transmissive zones 1182 are alternately arranged. The plurality of transmissive zones 1182 are configured to allow the fifth beam L15 and the sixth beam L16 to pass through. The plurality of reflection zones 1181 are configured to reflect the portion of the third beam L13′ and the portion of the fourth beam L14′. In this embodiment, the first optical element 117 and the second optical element 118 are arranged in parallel in the third direction Z.

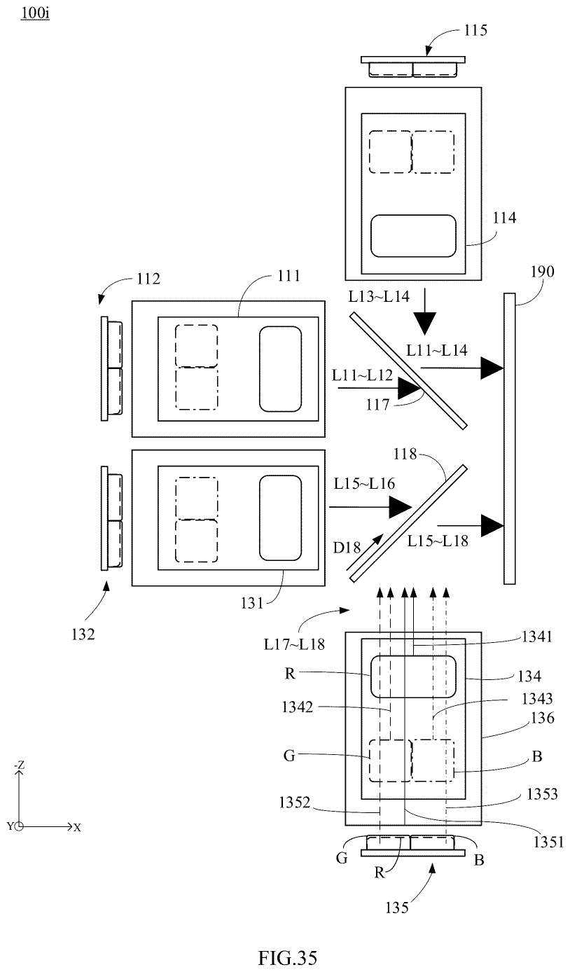

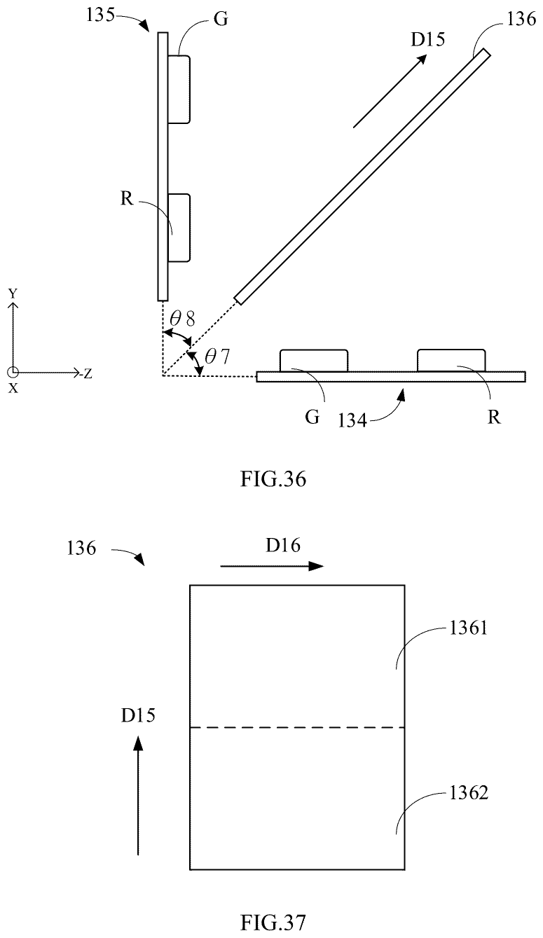

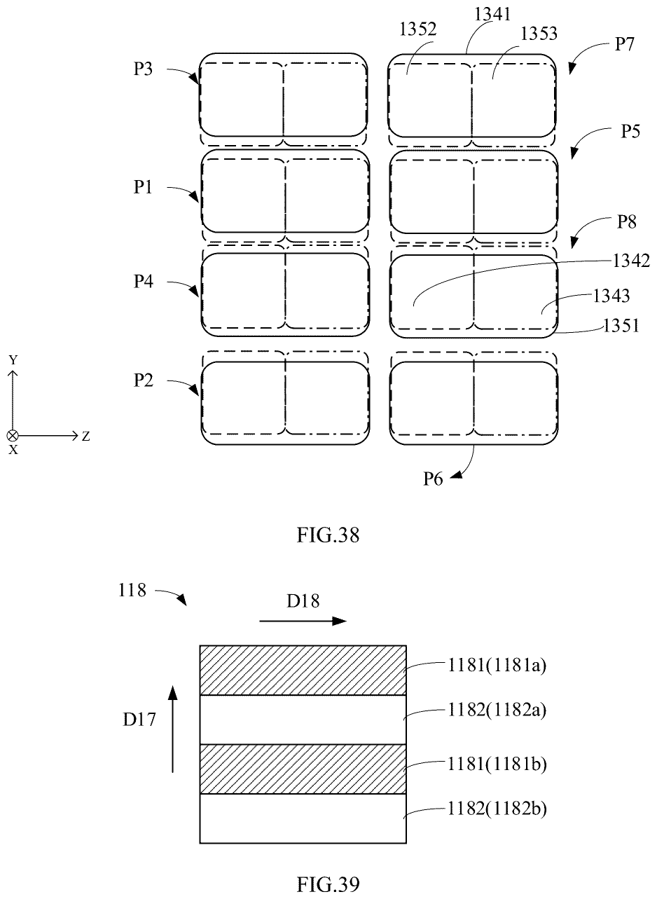

Please refer to FIG. 35 to FIG. 39. FIG. 36 is a schematic of a configuration example of a light splitting element according to an embodiment of the present disclosure. FIG. 37 is a schematic of a light splitting element according to an embodiment of the present disclosure. FIG. 38 is a schematic of light spots according to an embodiment of the present disclosure. FIG. 39 is a schematic of an optical element according to an embodiment of the present disclosure. The difference between the embodiments of FIG. 35 and FIG. 32 is that the illumination system 100i includes a seventh light source module 134, an eighth light source module 135 and a fourth light splitting element 136. The seventh light source module 134 includes a first sub-light emitting unit R, a second sub-light emitting unit G and a third sub-light emitting unit B. The seventh light source module 134 is configured to provide a seventh beam L17 transmitted along the first direction Y. The seventh beam L17 includes at least one of the first sub beam 1341, the second sub beam 1342 and the third sub beam 1343. The eighth light source module 135 includes a first sub-light emitting unit R, a second sub-light emitting unit G and a third sub-light emitting unit B, as shown in FIG. 4. The eighth light source module 135 is configured to provide an eighth beam L18 transmitted along a fourth direction-Z. The fourth direction-Z is parallel to and opposite to the third direction Z. The eighth beam L18 includes at least one of the first sub beam 1351, the second sub beam 1352, and the third sub beam 1353. The fourth light splitting element 136 is disposed between the seventh light source module 134 and the eighth light source module 135. The fourth light splitting element 136 is configured to reflect the seventh beam L17 and to allow the eighth beam L18 to pass through such that the seventh beam L17 and the eighth beam L18 are transmitted toward the second optical element 118. In the embodiment, the fourth light splitting element 136 and the first light splitting element 113 may be the same element. The fourth light splitting element 136 is disposed parallel to a fifteenth extension direction D15 and a sixteenth extension direction D16. The fifteenth extension direction D15 is, for example, a direction that is 45 degrees from the first direction Y and the fourth direction-Z. The sixth extension direction D16 is, for example, a direction parallel to the second direction X. The extending plane of the fourth light splitting element 136 and the extending plane of the seventh light source module 134 have an included angle θ7. An extending plane of the fourth light splitting element 136 and an extending plane of the eighth light source module 135 have an included angle θ8. The included angle θ7 and the included angle θ8 are, for example, 45 degrees. The fourth light splitting element 136 includes a first light splitting zone 1361 and a second light splitting zone 1362. The first light splitting zone 1361 and the second light splitting zone 1362 are arranged along the fifteenth extension direction D15. The first light splitting zone 1361 is configured to reflect the first sub beam 1341 of the seventh beam L17 such that the first sub beam 1341 of the seventh beam L17 is transmitted to the second optical element 118 along the fourth direction-Z. The first light splitting zone 1361 allows the second sub beam 1352 and the third sub beam 1353 of the eighth beam L18 to pass through. The second light splitting zone 1362 is configured to reflect the second sub beam 1342 and the third sub beam 1343 of the seventh beam L17 such that the second sub beam 1342 and the third sub beam 1343 of the seventh beam L17 are transmitted to the second optical element 118 along the fourth direction-Z. The second light splitting zone 1362 allows the first sub beam 1351 of the eighth light beam L18 to pass through. In the embodiment, the first light source module 111, the second light source module 112, the first light splitting element 113, the third light source module 114, the fourth light source module 115, the second light splitting element 116 and the first optical element 117 may be implemented by the embodiment of FIG. 8 and thus are not described in detail herein.

In this embodiment, the second optical element 118 is configured to allow the fifth beam L15 and the sixth beam L16 to pass through and is configured to reflect the seventh beam L17 and the eighth beam L18. The second optical element 118 transmits the seventh beam L17 and the eighth beam L18 to the optical element 190 along the second direction X. The second optical element 118 is arranged parallel to a seventeenth extension direction D17 and an eighteenth extension direction D18. The seventeenth extension direction D17 is, for example, a direction parallel to the first direction Y. The eighth extension direction D18 is, for example, a direction inclined with respect to the second direction X. The reflection zone 1181a of the second optical element 118 is configured to reflect the second sub beam 1352 and the third sub beam 1353 of the eighth beam L18 and the first sub beam 1341 of the seventh beam L17. The reflection zone 1181b of the second optical element 118 is configured to reflect the second sub beam 1342 and the third sub beam 1343 of the seventh beam L17 and the first sub beam 1351 of the eighth beam L18. The transmissive zone 1182a of the second optical element 118 is configured to allow the second sub beam 1322 and the third sub beam 1323 of the sixth beam L16 and the first sub beam 1311 of the fifth beam L15 to pass through. The transmissive zone 1182b of the second optical element 118 is configured to allow the second sub beam 1312 and the third sub beam 1313 of the fifth beam L15 and the first sub beam 1321 of the sixth beam L16 to pass through. The fifth light source module 131 and the sixth light source module 132 are symmetrically disposed with the seventh light source module 134 and the eighth light source module 135 along the extending direction of the second optical element 118. The fifth light source module 131, the sixth light source module 132, the seventh light source module 134, the eighth light source module 135, and the second optical element 118 are symmetrically disposed with the first light source module 111, the second light source module 112, the third light source module 114, the fourth light source module 115, and the first optical element 117 along the optical axis (not shown in the figure) of the optical element 190. The optical axis of the optical element 190 is parallel to the second direction X.

In this embodiment, the light spots formed by the first sub beam 1341 of the seventh beam L17 on the optical element 190 at least partially overlap with the light spots formed by the second sub beam 1352 and the third sub beam 1353 of the eighth beam L18 on the optical element 190 to form a seventh light spot group P7. The light spots formed by the first sub beam 1351 of the eighth beam L18 on the optical element 190 at least partially overlap with the light spots formed by the second sub beam 1342 and the third sub beam 1343 of the seventh beam L17 on the optical element to form an eighth light spot group P8. The seventh light spot group P7 and the eighth light spot group P8 are arranged along the first direction Y. The fifth light spot group P5, the sixth light spot group P6, the seventh light spot group P7 and the eighth light spot group P8 are alternately arranged along the first direction Y. The sixth light spot group P6, the eighth light spot group P8, the fifth light spot group P5 and the seventh light spot group P7 are sequentially arranged along in the first direction Y.

According to the above, the embodiments of the present disclosure at least have one of the following beneficial effects: The illumination system and projection device of the embodiments of the present disclosure allow at least two light spots to at least partially overlap on the optical element, which may effectively increase the brightness of the illumination beam without increasing the volume of the projection device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents, in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may use the terms “first”, “second”, etc. followed by a noun or element. Such terms should be understood as nomenclature and should not be construed as giving a limitation on the number of the elements modified by such nomenclature unless a specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element or component in the present disclosure is intended to be dedicated to the public regardless of whether the element or component is explicitly recited in the following claims.

1. An illumination system, comprising:
a first light source module, providing a first beam transmitted along a first direction, wherein the first beam comprises at least one of a first sub beam, a second sub beam and a third sub beam;
a second light source module, providing a second beam transmitted along a second direction, wherein the second beam comprises at least one of a first sub beam, a second sub beam and a third sub beam, and the first direction is different from the second direction:
a first light splitting element, disposed between the first light source module and the second light source module, wherein the first light splitting element reflects the first beam and causes the first beam to be transmitted to an optical element along the second direction, wherein the first light splitting element allows the second beam to pass through and the second beam is transmitted to the optical element along the second direction,
wherein a light spot formed by the first sub beam of the first beam on the optical element is respectively at least partially overlapped with light spots formed by the second sub beam and third sub beam of the second beam on the optical element to form a first light spot group, a light spot formed by the first sub beam of the second beam on the optical element is respectively at least partially overlapped with light spots formed by the second sub beam and third sub beam of the first beam on the optical element to form a second light spot group, and the first light spot group and the second light spot group are arranged along the first direction.

2. The illumination system as claimed in claim 1, wherein the first light splitting element comprises a first light splitting zone and a second light splitting zone, the first light splitting zone reflects the second sub beam and third sub beam of the first beam and allows the first sub beam of the second beam to pass through, and the second light splitting zone reflects the first sub beam of the first beam and allows the second sub beam and the third sub beam of the second beam to pass through.

3. The illumination system as claimed in claim 1, wherein the first light source module comprises a first light emitting unit, a second light emitting unit and a third light emitting unit, the second light emitting unit and third light emitting unit are disposed in parallel, and the first light emitting unit is disposed on the same side as the second light emitting unit and the third light emitting unit.

4. The illumination system as claimed in claim 1, wherein the first light source module and the second light source module are disposed to form an L-shaped configuration.

5. The illumination system as claimed in claim 1, further comprising:
a third light source module, providing a third beam transmitted along the first direction:
a fourth light source module, providing a fourth beam transmitted along a third direction, wherein the third direction is different from the first direction and the second direction:
a second light splitting element, disposed between the third light source module and the fourth light source module, wherein the second light splitting element reflects the third beam and allows the fourth beam to pass through; and
a first optical element, for allowing at least a part of the first beam and second beam to pass through and for reflecting at least a part of the third beam and the fourth beam to cause the first beam, second beam, third beam and fourth beam to be transmitted to the optical element:
wherein light spots formed by at least part of the third beam on the optical element and light spots formed by at least part of the fourth beam on the optical element are at least partially overlapped and form a third light spot group and a fourth light spot group, and the third light spot group and the fourth light spot group are arranged along the first direction.

6. The illumination system as claimed in claim 5, wherein the first optical element is a zoned optical element, the zoned optical element comprises a plurality of first transmissive zones and a plurality of first reflection zones, and the plurality of first transmissive zones and the plurality of first reflection zones are alternately arranged.

7. The illumination system as claimed in claim 6, wherein the third light source module and the fourth light source module are symmetrically disposed with respect to the first light source module and the second light source module respectively along an extending direction of the first optical element, wherein the plurality of first transmissive zones and the plurality of first reflection zones are arranged alternately along the extending direction.

8. The illumination system as claimed in claim 5, wherein the first light spot group, the second light spot group, the third light spot group and the fourth light spot group are alternately arranged in the first direction.

9. The illumination system as claimed in claim 5, further comprising: a second optical element: wherein,
the first optical element is a partially transmissive and partially reflective optical element, the partially transmissive and partially reflective optical element is configured to allow portions of the first beam, the second beam, the third beam and the fourth beam to pass through and to reflect the other portions of the first beam, the second beam, the third beam and the fourth beam; and
the second optical element is disposed on a transmission path of the portions of the third beam and the fourth beam from the first optical element and is disposed on a transmission path of the other portions of the first beam and the second beam from the first optical element, the second optical element reflects the other portions of the first beam and the second beam and the portions of the third beam and the fourth beam such that the other portions of the first beam and the second beam and the portions of the third beam and the fourth beam are transmitted to the optical element,
wherein, a plurality of light spots formed by the other portion of the first beam on the optical element at least partially overlap with a plurality of light spots formed by the other portion of the second beam on the optical element to form a first sub-light spot group and a second sub-light spot group, a plurality of light spots formed by the portion of the third beam on the optical element at least partially overlap with a plurality of light spots formed by the portion of the fourth beam on the optical element to form a third sub-light spot group and a fourth sub-light spot group, and the first sub-light spot group, the second sub-light spot group, the third sub-light spot group and the fourth sub-light spot group are alternately arranged in the first direction.

10. The illumination system as claimed in claim 9, wherein the first, second, third and fourth light spot groups are respectively arranged with the first, second, third and fourth sub-light spot groups along the third direction.

11. The illumination system as claimed in claim 10, further comprising:
a third optical element, disposed on a transmission path of the first light beam and the second light beam from the first light splitting element, for reflecting at least a portion of the first beam and a portion of the second beam such that the at least a portion of the first beam and the at least a portion of the second beam is transmitted to the first optical element.

12. The illumination system as claimed in claim 11, wherein the first light source module and the second light source module are respectively disposed in parallel with the third light source module and the fourth light source module.

13. The illumination system as claimed in claim 10, further comprising:
a fourth optical element:
wherein the third optical element is configured to allow a first portion of the first beam and a first portion of the second beam to pass through and be transmitted to the fourth optical element, and the third optical element is configured to reflect a second part of the first beam and a second part of the second beam such that the second parts of the first beam and the second beam are transmitted to the first optical element:
wherein the fourth optical element is configured to reflect the first portion of the first beam and the first portion of the second beam such that the first portions of the first beam and the second beam are transmitted to the second optical element,
wherein the second optical element is configured to allow the first portions of the first beam and the second beam to pass through.

14. The illumination system as claimed in claim 10, wherein the first optical element comprises at least one partially reflective zone, the second optical element comprises a plurality of reflection zones and a plurality of transmissive zones, the plurality of reflection zones and the plurality of transmissive zones of the second optical element are alternately arranged, the third optical element comprises at least one partially reflective zone, and the fourth optical element comprises at least one reflection zone.

15. The illumination system as claimed in claim 13, further comprising:
a fifth light source module, for providing a fifth beam:
wherein the third optical element is configured to reflect at least a portion of the fifth beam to cause the portion of the fifth light beam to be transmitted to the fourth optical element:
wherein the third optical element is configured to allow the other portion of the fifth beam to pass through such that the other portion of the fifth beam is transmitted to the first optical element.

16. The illumination system as claimed in claim 5, further comprising:
a fifth light source module, for providing a fifth beam transmitted along the first direction:
a sixth light source module, for providing a sixth beam transmitted along the second direction:
a third light splitting element, for reflecting the fifth beam and for allowing the sixth beam to pass through such that the fifth beam and the sixth beam are transmitted to the optical element:
wherein, a plurality of light spots formed by at least a portion of the fifth beam on the optical element are at least partially overlapped with a plurality of light spots formed by at least a portion of the sixth beam on the optical element to form a fifth light spot group and a sixth light spot group, and the fifth light spot group and the sixth light spot group are arranged along the first direction.

17. The illumination system as claimed in claim 16, wherein the fifth and sixth light spot groups and the first, second, third and fourth light spot groups are arranged along the third direction.

18. The illumination system as claimed in claim 16, wherein the fifth light source module and the sixth light source module are respectively disposed in parallel with the first light source module and the second light source module.

19. The illumination system as claimed in claim 16, further comprising:
a second optical element:
wherein the first optical element is for allowing a portion of the third beam and a portion of the fourth beam to pass through and for reflecting the other portions of the third beam and the fourth beam:
wherein the second optical element is configured to allow the fifth beam and the sixth beam to pass through and is configured to reflect portions of the third beam and the fourth beam such that the portion of the third beam, the portion of the fourth beam, the fifth beam and the sixth beam are transmitted to the optical element.

20. The illumination system as claimed in claim 19, wherein the first optical element comprises a plurality of partially reflective zones and a plurality of transmissive zones, the plurality of partially reflective zones and the plurality of transmissive zones of the first optical element are alternately arranged, the second optical element comprises a plurality of reflection zones and a plurality of transmissive zones, and the plurality of reflection zones and the plurality of transmissive zones of the second optical element are alternately arranged.

21. The illumination system as claimed in claim 16, further comprising:
a seventh light source module, for providing a seventh beam transmitted along the first direction:
an eighth light source module, for providing an eighth beam transmitted along a fourth direction, wherein the fourth direction is parallel to the third direction:
a fourth light splitting element, for reflecting the seventh beam and allowing the eighth beam to pass through:
a second optical element, for allowing the fifth beam and the sixth beam to pass through, and for reflecting the seventh beam and the eighth beam such that the seventh beam and the eighth beam are transmitted to the optical element:
wherein a plurality of light spots formed by at least a portion of the seventh beam on the optical element are at least partially overlapped with a plurality of light spots formed by at least a portion of the eighth beam on the optical element to form a seventh light spot group and an eighth light spot group, and the seventh light spot group and the eighth light spot group are arranged along the first direction.

22. The illumination system as claimed in claim 21, wherein the fifth light spot group, the sixth light spot group, the seventh light spot group, and the eighth light spot group are alternately arranged in the first direction.

23. The illumination system as claimed in claim 21, wherein the first optical element and the second optical element comprise a plurality of reflection zones and a plurality of transmissive zones, and the plurality of reflection zones and the plurality of transmissive zones are alternately arranged.

24. The illumination system as claimed in claim 23, wherein the fifth and sixth light source modules are respectively symmetrically disposed with and the seventh and eighth light source modules along an extending direction of the second optical element, and the plurality of transmissive zones and the plurality of reflection zones of the second optical element are disposed alternately along the extending direction.

25. A projection device, comprising:
an illumination system according to claim 1, configured to provide an illumination beam, the illumination beam comprising at least one of the first beam and the second beam from the optical element:
a light valve module, disposed on a transmission path of the illumination beam, configured to convert the illumination beam into an image beam; and
a projection lens, disposed on a transmission path of the image beam, configured to project the image beam out of the projection device.
